(19) United States
(12) Patent Application Publication
(10) Pub. No.: US 2025/0360413 A1
(43) Pub. Date: Nov. 27, 2025

(54) VIRTUAL OBJECT CONTROL METHOD AND APPARATUS, COMPUTER DEVICE, AND STORAGE MEDIUM

(71) Applicant: Tencent Technology (Shenzhen) Company Limited, Shenzhen (CN)

(72) Inventors: Yang YAO, Shenzhen (CN); Litian ZHANG, Shenzhen (CN)

(21) Appl. No.: 19/295,292

(22) Filed: Aug. 8, 2025

Related U.S. Application Data
(63) Continuation of application No. PCT/CN2024/085566, filed on Apr. 2, 2024.

(30) Foreign Application Priority Data
May 31, 2023 (CN) 202310641508.9

(51) Int. Cl. A63F 13/577; A63F 13/69; G06T 19/20

(52) U.S. Cl. CPC A63F 13/577; A63F 13/69; G06T 19/20; G06T 2210/21; G06T 2219/2004

(57) ABSTRACT

A virtual object control method is performed by a computer device, and the method includes: in response to a first moving operation on a virtual object on a scene interface, predicting a first scene location based on the first moving operation and moving the virtual object toward the first predicted scene location; determining a first scene location according to a moving instruction returned by a server for the first moving operation; and calibrating a display location of the virtual object on the scene interface based on the first scene location when the first scene location is different from the first predicted scene location.

### CROSS-REFERENCE TO RELATED APPLICATIONS

This application is a continuation application of PCT Patent Application No. PCT/CN2024/085566, entitled “VIRTUAL OBJECT CONTROL METHOD AND APPARATUS, COMPUTER DEVICE, AND STORAGE MEDIUM” filed on Apr. 2, 2024, which claims priority to Chinese Patent Application No. 202310641508.9, entitled “VIRTUAL OBJECT CONTROL METHOD AND APPARATUS, COMPUTER DEVICE, AND STORAGE MEDIUM” filed on May 31, 2023, both of which are incorporated herein by reference in their entirety.

### FIELD OF THE TECHNOLOGY

Embodiments of this application relate to the field of computer technologies, and in particular, to a virtual object control method and apparatus, a computer device, and a storage medium.

### BACKGROUND OF THE DISCLOSURE

With development of computer technologies, games are increasingly popular among users. In a massively multiplayer online role-playing game, a player can control a virtual object to move in a virtual scene.

### SUMMARY

Embodiments of this application provide a virtual object control method and apparatus, a computer device, and a storage medium, to avoid a delay of a moving operation, ensure data accuracy, and therefore improve user experience. Technical solutions are as follows:

According to an aspect, a virtual object control method is performed by a computer device. The method includes:
in response to a first moving operation on a virtual object on a scene interface, predicting a first scene location based on the first moving operation and moving the virtual object toward the first predicted scene location;
determining a first scene location according to a moving instruction returned by a server for the first moving operation; and
calibrating a display location of the virtual object on the scene interface based on the first scene location when the first scene location is different from the first predicted scene location.

According to another aspect, a computer device is provided. The computer device includes a processor and a memory. The memory has at least one computer program stored therein. The at least one computer program, when executed by the processor, causes the computer device to implement the operations performed in the virtual object control method in the foregoing aspects.

According to another aspect, a non-transitory computer-readable storage medium is provided. The computer-readable storage medium has at least one computer program stored therein. The at least one computer program, when executed by a processor of a computer device, causes the computer device to implement the operations performed in the virtual object control method in the foregoing aspects.

In the embodiments of this application, a terminal predicts, in response to a first moving operation, a first predicted scene location that a virtual object may reach in a virtual scene under the action of the first moving operation; displays, on a scene interface, the virtual object moving toward the first predicted scene location obtained through prediction; and then determines a first scene location of the virtual object in the virtual scene according to a moving instruction returned by a server, compares the determined first scene location with the first predicted scene location, and calibrates a display location of the virtual object on the scene interface when the first predicted scene location obtained through prediction is inaccurate. In this way, the display location of the virtual object on the scene interface is synchronized, as much as possible, with a scene location that the virtual object is to reach in the virtual scene, to ensure accuracy of the display location of the virtual object on the scene interface. In addition, the terminal can respond to the first moving operation in a timely manner without waiting for a long time for the moving instruction delivered by the server, to avoid a delay in responding to the moving operation, so that the terminal can display a picture of movement of the virtual object on the scene interface in a timely manner. This avoids frame freezing of the picture displayed by the terminal, and therefore can improve user experience.

### BRIEF DESCRIPTION OF THE DRAWINGS

FIG. 1 is a schematic diagram of a structure of an implementation environment according to an embodiment of this application.

FIG. 2 is a flowchart of a virtual object control method according to an embodiment of this application.

FIG. 3 is a flowchart of another virtual object control method according to an embodiment of this application.

FIG. 4 is a flowchart of another virtual object control method according to an embodiment of this application.

FIG. 5 is a flowchart of another virtual object control method according to an embodiment of this application.

FIG. 6 is a schematic diagram of calibrating a predicted scene location according to an embodiment of this application.

FIG. 7 is a flowchart of another virtual object control method according to an embodiment of this application.

FIG. 8 is a flowchart of another virtual object control method according to an embodiment of this application.

FIG. 9 is a flowchart of another virtual object control method according to an embodiment of this application.

FIG. 10 is a flowchart of another virtual object control method according to an embodiment of this application.

FIG. 11 is a schematic diagram of a movement hand feel indicator according to an embodiment of this application.

FIG. 12 is a flowchart of another virtual object control method according to an embodiment of this application.

FIG. 13 is a schematic diagram of a structure of a virtual object control apparatus according to an embodiment of this application.

FIG. 14 is a schematic diagram of a structure of a terminal according to an embodiment of this application.

FIG. 15 is a schematic diagram of a structure of a server according to an embodiment of this application.

### DESCRIPTION OF EMBODIMENTS

The terms “first”, “second”, “third”, and the like used in this application may be configured for describing various concepts in this specification. However, unless otherwise specified, the concepts are not limited by the terms. The terms are merely configured for distinguishing one concept from another concept. For example, without departing from the scope of this application, a first scene location may be referred to as a second scene location, and similarly, a second scene location may be referred to as a first scene location.

Among the terms “at least one”, “a plurality of”, “each”, and “any one” used in this application, “at least one” includes one, two, or more, “a plurality of” includes two or more, “each” indicates each of a plurality of corresponding items, and “any one” indicates any one of a plurality of items. For example, a plurality of terminals include three terminals, “each” indicates each of the three terminals, and “any one” indicates any one of the three terminals, which may be the 1^{st} terminal, the 2^{nd} terminal, or the 3^{rd} terminal.

For ease of understanding the embodiments of this application, some terms in the embodiments of this application are first described.

Multiplayer online battle arena (MOBA) game: A MOBA game includes at least two camps that interact with each other in a same virtual scene. For example, a MOBA game includes two camps, and a player controls, by using a terminal, a virtual object to interact with a virtual object from another camp in a virtual scene.

Virtual scene: It is a virtual scene displayed (or provided) by an application when the application is run on a terminal, in other words, a scene displayed when a game is run on the terminal. For example, the game is a shooting game, and the virtual scene is a scene displayed when the game is run on the terminal. The virtual scene is a simulated environment of a real world, a semi-simulated semi-fictional virtual environment, or a purely fictional virtual environment. The virtual scene is any one of a two-dimensional virtual scene, a 2.5-dimensional virtual scene, or a three-dimensional virtual scene. This is not limited in this application. For example, the virtual scene includes the sky, the land, or the ocean. The land includes environmental elements such as the desert and a city. A user can control a virtual object to move in the virtual scene. Certainly, the virtual scene further includes a virtual item, for example, a virtual thrown object, a virtual building, or a virtual machine. The virtual scene can be further configured for simulating real environments in different weather, for example, a sunny day, a rainy day, a foggy day, or a night. Various scene elements enhance diversity and realness of the virtual scene. For example, the virtual scene is an open virtual world provided by a game. The open virtual world indicates that a virtual scene in the game is completely free and open. A player can control a virtual object to freely move forward in any direction for exploration, and a distance between boundaries in different directions is quite large. In addition, the virtual scene also includes virtual items of various shapes and sizes, which can physically collide or interact with entities, such as a virtual object or an artificial intelligence (AI) object, controlled by the player.

Virtual object: It is a movable virtual character in a virtual scene. The movable object is a virtual person, a virtual animal, a cartoon person, or the like. The virtual object is a virtual image configured for representing a user in the virtual scene. The virtual scene includes a plurality of virtual objects, and each virtual object has a shape and a volume in the virtual scene, and occupies some space in the virtual scene. The virtual object can perform activities such as crawling, walking, running, jumping, driving, picking, shooting, attacking, and throwing in the virtual scene. In some embodiments, the virtual object is a character controlled through an operation on a client, an AI object configured in a virtual environment through training, or a non-player character (NPC) configured in the virtual scene. In some embodiments, the virtual object is a virtual person competing in the virtual scene.

Virtual item: It is an item that can be used by a virtual object in a virtual scene. For example, the virtual item is a virtual gun or a virtual vehicle. In a virtual scene, a virtual object can interact with another virtual object by using a virtual item.

All moving operations, release operations, and data (including but not limited to game data configured for rendering a scene interface, and the like) in this application are authorized by a user or fully authorized by all parties, and collection, use, and processing of related data need to comply with related laws, regulations, and standards in related countries and regions. For example, all game data configured for rendering a scene interface in this application is obtained with full authorization.

Currently, when a player controls, by using a terminal, a virtual object to move in a virtual scene, the terminal transmits a moving request to a server, and the server transmits, for the moving request, a moving instruction to a plurality of terminals participating in a game, so that each terminal displays, according to the moving instruction, a picture of the virtual object moving in the virtual scene. However, in this manner, the terminal needs to wait for a long time for the moving instruction delivered by the server, and a response to a moving operation is delayed, leading to frame freezing of a displayed picture.

A virtual object control method provided in the embodiments of this application is performed by a computer device. In some embodiments, the computer device is a terminal or a server. In some embodiments, the server is an independent physical server, a server cluster or a distributed system that includes a plurality of physical servers, or a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. In some embodiments, the terminal is a smartphone, a tablet computer, a notebook computer, a desktop computer, a smart speaker, a smartwatch, a smart voice interaction device, a smart home appliance, an in-vehicle terminal, or the like, but is not limited thereto.

In some embodiments, a computer program in the embodiments of this application may be deployed on one computer device for execution, or may be executed on a plurality of computer devices at one location, or may be executed on a plurality of computer devices that are distributed at a plurality of locations and that are interconnected through a communication network. The plurality of computer devices that are distributed at a plurality of locations and that are interconnected through a communication network can form a blockchain system.

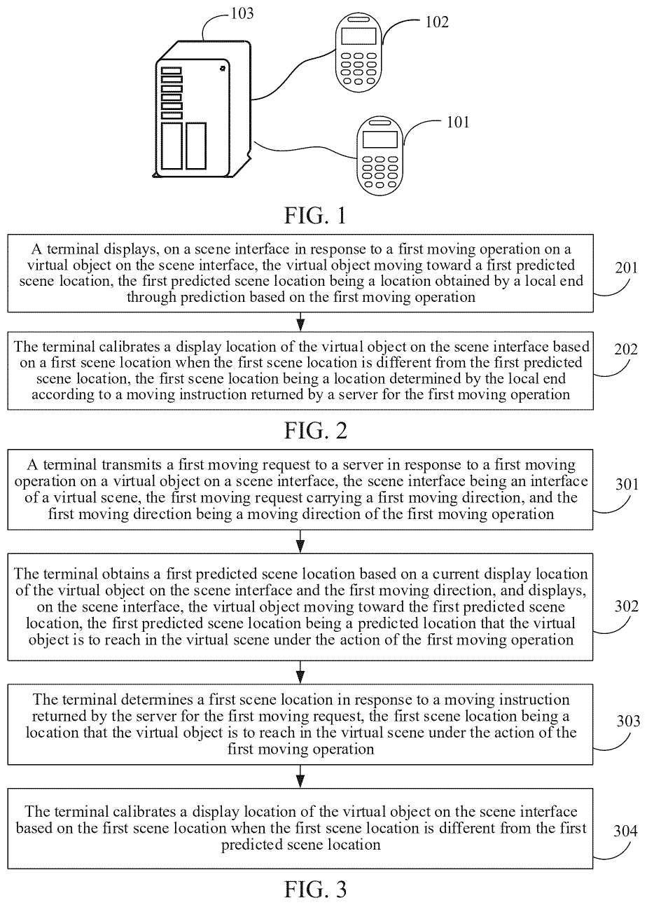

In some embodiments, the computer device is provided as a first terminal. FIG. 1 is a schematic diagram of an implementation environment according to an embodiment of this application. As shown in FIG. 1, the implementation environment includes a first terminal 101, a second terminal 102, and a server 103. Both the first terminal 101 and the second terminal 102 are connected to the server 103 through a wired or wireless network. An application for which the server 103 provides a service is installed on both the first terminal 101 and the terminal 102. The first terminal 101 and the second terminal 102 can implement functions such as a game and message exchange by using the application. In some embodiments, the application is an application in an operating system of the first terminal 101, or an application provided by a third party. For example, the application is a game application, and the game application has a game function. Certainly, the game application can further have other functions such as a shopping function and a navigation function. The first terminal 101 is a first terminal used by any user. The user can control, by using the first terminal 101, a virtual object in a virtual scene to perform an activity. The activity includes, but is not limited to, at least one of crawling, walking, running, jumping, driving, picking, shooting, attacking, and throwing. In some embodiments, different users respectively use different first terminals to control virtual objects, and the virtual objects controlled by the different first terminals are located in the same virtual scene. In this case, the different virtual objects can perform activities.

The first terminal 101 is configured to log in to the application based on a user identity, and interact with the server 103 through the application, to display a scene interface of a virtual scene. The first terminal 101 can pre-display movement of a virtual object on the scene interface by using the application in response to a moving operation on the virtual object on the scene interface, and interact with the server 103 through the application, so that the server 103 transmits a moving instruction for the moving operation to the first terminal 101 and a second terminal 102 participating in a same game. In this way, the first terminal 101 can determine a scene location of the virtual object in the virtual scene according to the moving instruction, to ensure that the scene location of the virtual object in the virtual scene is synchronized with a display location of the virtual object on the scene interface. In addition, the second terminal 102 can determine a scene location of the virtual object in the virtual scene according to the moving instruction, and then display the virtual object on a scene interface based on the determined scene location, to ensure synchronization of the scene locations of the virtual object in the virtual scene on the first terminal 101 and the second terminal 102.

In this embodiment of this application, one second terminal 102 is used as an example for description. In another embodiment, the implementation environment can alternatively include a plurality of second terminals 102 that can interact with the server 103 to display a scene interface of a virtual scene according to the manner of the foregoing second terminal 102.

FIG. 2 is a flowchart of a virtual object control method according to an embodiment of this application. For example, the method is performed by a terminal. As shown in FIG. 2, the method includes the following operations:

201: The terminal displays, on a scene interface in response to a first moving operation on a virtual object on the scene interface, the virtual object moving toward a first predicted scene location, the first predicted scene location being a location obtained by a local end through prediction based on the first moving operation.

202: The terminal calibrates a display location of the virtual object on the scene interface based on a first scene location when the first scene location is different from the first predicted scene location, the first scene location being a location determined by the local end according to a moving instruction returned by a server for the first moving operation.

In this embodiment of this application, the terminal predicts, based on the first moving operation in response to the first moving operation, the first predicted scene location that the virtual object may reach; displays, on the scene interface, the virtual object moving toward the first predicted scene location obtained through prediction; and then determines, according to the moving instruction returned by the server, a scene location that the virtual object is actually to reach, and calibrates the display location of the virtual object on the scene interface when the first scene location is different from the first predicted scene location, which indicates that the first predicted scene location obtained through prediction is inaccurate. In this way, the display location of the virtual object on the scene interface can be accurate as much as possible, and the terminal can respond to the first moving operation in a timely manner without waiting for a long time for the moving instruction delivered by the server, to avoid a delay in responding to the moving operation, so that the terminal can display a picture of movement of the virtual object on the scene interface in a timely manner. This avoids frame freezing of the picture displayed by the terminal, and therefore can improve user experience.

FIG. 3 is a flowchart of a virtual object control method according to an embodiment of this application. For example, the method is performed by a terminal. As shown in FIG. 3, the method includes the following operations:

301: The terminal transmits a first moving request to a server in response to a first moving operation on a virtual object on a scene interface, the scene interface being an interface of a virtual scene, the first moving request carrying a first moving direction, and the first moving direction being a moving direction of the first moving operation.

In this embodiment of this application, the terminal displays the scene interface of the virtual scene, the virtual object is displayed on the scene interface, and the virtual object is a virtual object controlled by the terminal. When the virtual object is displayed, a user can trigger a moving operation on the virtual object on the scene interface displayed by the terminal, to control the virtual object to move in the virtual scene, so that the terminal can display movement of the virtual object on the scene interface. The terminal detects the first moving operation on the virtual object based on the scene interface, and transmits the first moving request to the server, so that the server can deliver, in response to the first moving request, a moving instruction to a plurality of terminals participating in a same round of game as the terminal, to ensure synchronization of game data of the plurality of terminals.

The first moving operation is any operation. For example, the first moving operation indicates location movement of the virtual object in the virtual scene, orientation rotation of the virtual object, or the like. For another example, the first moving operation indicates the virtual object to move toward the first moving direction, and the first moving direction is any direction. For example, the first moving operation indicates the virtual object to move eastward or westward. The scene interface of the virtual scene is configured to display content of the virtual scene. For example, the scene interface can display a virtual object, a virtual building, or a virtual vehicle in the virtual scene.

302: The terminal obtains a first predicted scene location based on a current display location of the virtual object on the scene interface and the first moving direction, and displays, on the scene interface, the virtual object moving toward the first predicted scene location, the first predicted scene location being a predicted location that the virtual object is to reach in the virtual scene under the action of the first moving operation.

In this embodiment of this application, the terminal records a scene location of the virtual object in the virtual scene, to display the virtual object on the scene interface based on the recorded scene location. On the terminal, the current display location of the virtual object on the scene interface may be different from a scene location, currently recorded by the terminal, of the virtual object in the virtual scene, or may be the same as the scene location recorded by the terminal. Therefore, in response to the moving operation on the virtual object, the terminal predicts a scene location that the virtual object may reach in the virtual scene under the action of the first moving operation, and then displays, on the scene interface, the virtual object moving toward the first predicted scene location obtained through prediction, so that the terminal can respond to the first moving operation in a timely manner. In addition, this can ensure, as much as possible, that the display location of the virtual object on the scene interface is the same as the scene location, recorded by the terminal, of the virtual object in the virtual scene, to ensure accuracy of movement of the virtual object displayed by the terminal. For a plurality of terminals participating in a same round of game as the terminal, scene locations of the virtual object in the virtual scene that are recorded by the plurality of terminals are the same.

The first predicted scene location is a location obtained by a local end through prediction based on the first moving operation. In other words, the first predicted scene location is a location that is predicted by the local end and that the virtual object may reach under the action of the first moving operation.

In this embodiment of this application, after transmitting the first moving request to the server in response to the first moving operation, the terminal can update the scene location recorded by the terminal only when receiving a moving instruction returned by the server for the first moving operation. Because a network delay or the like may occur during interaction between the terminal and the server, a delay may occur in reception of a moving instruction by the terminal. Therefore, the terminal may predict, without waiting for a moving instruction returned by the server for the first moving operation, a location that the virtual object is to reach in the virtual scene under the action of the first moving operation, that is, obtain the first predicted scene location, and immediately control the virtual object to move toward the first predicted scene location, so that the terminal displays a picture of movement of the virtual object in a timely manner in response to the first moving operation on the virtual object, to avoid a delay in responding to the moving operation. In this way, the terminal can display the picture of movement of the virtual object on the scene interface in a timely manner, to avoid frame freezing of the picture displayed by the terminal.

303: The terminal determines a first scene location in response to a moving instruction returned by the server for the first moving request, the first scene location being a location that the virtual object is to reach in the virtual scene under the action of the first moving operation.

In this embodiment of this application, after receiving the first moving request transmitted by the terminal, the server returns the moving instruction to the terminal, and also returns the moving instruction to another terminal participating in a same round of game as the terminal, so that a terminal receiving the moving instruction updates a recorded scene location of the virtual object in the virtual scene according to the moving instruction, to ensure that the terminal can respond to the first moving operation and ensure that scene locations recorded by terminals participating in a same round of game are synchronized.

In this embodiment of this application, the first scene location is a location that the virtual object is to reach under the action of the first moving operation. After determining a scene location according to the moving instruction returned by the server, the terminal records the determined scene location, to subsequently determine a next scene location based on the recorded scene location in combination with a next moving instruction returned by the server.

The terminal updates the recorded scene location of the virtual object in the virtual scene in response to the moving instruction returned by the server. An updated scene location is the first scene location, and the first scene location is a scene location recorded at a logic layer of the terminal. The moving instruction returned by the server for the first moving request is equivalent to a moving instruction returned by the server for the first moving operation. Therefore, the first scene location is a location determined by the local end according to the moving instruction returned by the server for the first moving operation.

304: The terminal calibrates a display location of the virtual object on the scene interface based on the first scene location when the first scene location is different from the first predicted scene location.

In this embodiment of this application, the first predicted scene location is a scene location that is predicted by the terminal and that the virtual object may reach in the virtual scene under the action of the first moving operation, and the first scene location is a scene location determined by the terminal in response to the moving instruction returned by the server. The first scene location being different from the first predicted scene location indicates that the scene location predicted by the terminal is inaccurate. Therefore, the display location of the virtual object on the scene interface is calibrated based on the first scene location, so that the display location of the virtual object on the scene interface is synchronized, as much as possible, with a scene location that the virtual object is to reach in the virtual scene, to ensure accuracy of the display location of the virtual object on the scene interface.

In this embodiment of this application, the terminal predicts, in response to the first moving operation, the first predicted scene location that the virtual object may reach in the virtual scene under the action of the first moving operation; displays, on the scene interface, the virtual object moving toward the first predicted scene location obtained through prediction; and then determines the first scene location of the virtual object in the virtual scene according to the moving instruction returned by the server, compares the determined first scene location with the first predicted scene location, and calibrates the display location of the virtual object on the scene interface when the first predicted scene location obtained through prediction is inaccurate. In this way, the display location of the virtual object on the scene interface is synchronized, as much as possible, with the scene location that the virtual object is to reach in the virtual scene, to ensure accuracy of the display location of the virtual object on the scene interface. In addition, the terminal can respond to the first moving operation in a timely manner without waiting for a long time for the moving instruction delivered by the server, to avoid a delay in responding to the moving operation, so that the terminal can display a picture of movement of the virtual object on the scene interface in a timely manner. This avoids frame freezing of the picture displayed by the terminal, and therefore can improve user experience.

Based on the embodiment shown in FIG. 3, in an embodiment of this application, when the terminal receives the moving instruction returned by the server for the first moving operation, the terminal has responded to a plurality of moving operations on the virtual object on the scene interface, and has transmitted a plurality of moving requests to the server. For a specific process, refer to the following embodiment.

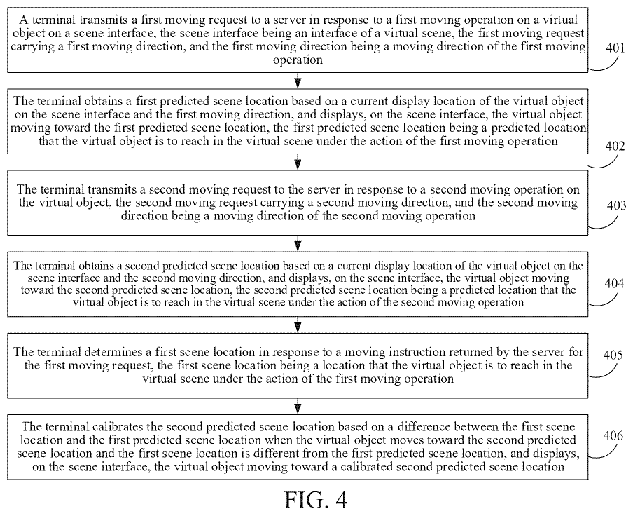

FIG. 4 is a flowchart of a virtual object control method according to an embodiment of this application. For example, the method is performed by a terminal. As shown in FIG. 4, the method includes the following operations:

401: The terminal transmits a first moving request to a server in response to a first moving operation on a virtual object on a scene interface, the scene interface being an interface of a virtual scene, the first moving request carrying a first moving direction, and the first moving direction being a moving direction of the first moving operation.

In a possible implementation, the scene interface displayed by the terminal is a user interface (UI) of the terminal.

In a possible implementation, a virtual joystick is displayed on the scene interface, and the terminal detecting a trigger operation on the virtual joystick on the scene interface is equivalent to detecting the first moving operation on the virtual object.

The virtual joystick is configured to control the virtual object to move in the virtual scene. In some embodiments, the virtual joystick includes a first area and a second area. A center of the first area overlaps a center of the second area. A user pressing the second area and performing dragging in any direction is equivalent to the first moving operation on the virtual object being detected. A dragging direction is the first moving direction of the first moving operation. In this embodiment of this application, the user can control, by using the virtual joystick displayed on the scene interface of the terminal, the virtual object to move on the scene interface.

In a possible implementation, a plurality of moving options for the virtual object are displayed on the scene interface, and different moving options correspond to different moving directions. Detecting a trigger operation on any moving option is equivalent to detecting the first moving operation on the virtual object, and a moving direction corresponding to the triggered moving option is the first moving direction.

In some embodiments, detecting a trigger operation on a plurality of moving options is equivalent to detecting the first moving operation on the virtual object. Moving directions corresponding to the plurality of triggered moving options are combined, and a combined direction is the first moving direction.

In a manner of combining the moving directions corresponding to the plurality of moving options, unit direction vectors of moving directions corresponding to all of the triggered moving options are combined by using a current location of the virtual object as a starting point, and a direction indicated by a combined vector is the first moving direction.

402: The terminal obtains a first predicted scene location based on a current display location of the virtual object on the scene interface and the first moving direction, and displays, on the scene interface, the virtual object moving toward the first predicted scene location, the first predicted scene location being a predicted location that the virtual object is to reach in the virtual scene under the action of the first moving operation.

In a possible implementation, a process of obtaining the first predicted scene location includes: determining, based on a current display location of the virtual object on the scene interface, a scene location corresponding to the display location in the virtual scene, the scene location being a current location of virtual object in the virtual scene; and obtaining the first predicted scene location based on the determined scene location, the first moving direction, a moving speed of the virtual object, and operation duration of the first moving operation.

In this embodiment of this application, the current display location of the virtual object on the scene interface may be the same as or different from a current scene location of the virtual object in the virtual scene. The scene location corresponding to the display location in the virtual scene is equivalent to a scene location, currently recorded by the terminal, of the virtual object in the virtual scene. A scene location that the virtual object is to reach after moving along the first moving direction based on the moving speed for the operation duration, that is, the first predicted scene location, may be determined based on the current scene location of the virtual object in the virtual scene, the first moving direction, the moving speed of the virtual object, and the operation duration of the first moving operation.

When the current display location of the virtual object on the scene interface is different from the scene location corresponding to the display location in the virtual scene, the scene location corresponding to the display location in the virtual scene lags behind the display location. To be specific, for a scene location, recorded by the terminal, of the virtual object in the virtual scene, the scene location may have not be adjusted based on a moving operation performed before the first moving operation, and the display location is a location obtained through adjustment based on the moving operation performed before the first moving operation. In the related art, when detecting a moving operation on a virtual object, a terminal waits to receive a moving instruction returned by a server for the moving operation. In response to the moving instruction, the terminal adjusts a scene location, recorded by the terminal, of the virtual object in a virtual scene and a display location of the virtual object on a scene interface, so that the scene location, recorded by the terminal, of the virtual object in the virtual scene is synchronized with the display location of the virtual object on the scene interface. However, in this embodiment of this application, when the terminal detects a moving operation on the virtual object, the terminal preferentially displays movement of the virtual object on the scene interface, to display, in a timely manner, a picture of the virtual object moving under the action of the moving operation. In this case, the terminal has not received a moving instruction returned by the server for the moving operation. Therefore, a scene location, recorded by the terminal, of the virtual object in the virtual scene has not changed, and the scene location, recorded by the terminal, of the virtual object in the virtual scene lags behind a display location of the virtual object on the scene interface.

In this embodiment of this application, the moving speed of the virtual object is related to an attribute of the virtual object. For example, the moving speed of the virtual object is related to a virtual vehicle currently taken by the virtual object or virtual equipment worn by the virtual object. The operation duration of the first moving operation is equivalent to duration in which the virtual object is controlled to move under the action of the first moving operation. In some embodiments, the operation duration of the first moving operation is trigger duration of the first moving operation. For example, if the first moving operation is a trigger operation on a moving option for the virtual object, duration for which the moving option is pressed is the operation duration; or if the first moving operation is triggered by using the virtual joystick, trigger duration of the virtual joystick is the operation duration.

In this embodiment of this application, the first predicted scene location is obtained based on the scene location corresponding to the display location in the virtual scene, the first moving direction, the moving speed of the virtual object, and the operation duration of the first moving operation, so that the first predicted scene location is a location that the virtual object may reach under the action of the first moving operation, to ensure accuracy of the first predicted scene location, and ensure accuracy of subsequently controlling movement of the virtual object based on the first predicted scene location.

In some embodiments, a process of obtaining the first predicted scene location includes: determining a product of the moving speed of the virtual object and the operation duration as a displacement, and determining a location that is away from a starting point by the displacement along the first moving direction as the first predicted scene location, the starting point being the determined scene location.

In this embodiment of this application, the displacement is determined based on the moving speed of the virtual object and the operation duration, and the first predicted scene location is determined based on the displacement, the first moving direction, and the scene location, currently recorded by the terminal, of the virtual object in the virtual scene, and to ensure accuracy of the first predicted scene location.

In a possible implementation, a process of obtaining the first predicted scene location includes: performing collision detection on the current display location of the virtual object on the scene interface, the first moving direction, and an environmental parameter of the virtual scene to obtain a collision result, the environmental parameter indicating an obstacle in the virtual scene, and the collision result indicating a collision status when the virtual object moves toward the first moving direction in the virtual scene; and obtaining the first predicted scene location based on the collision result, the current display location of the virtual object on the scene interface, and the first moving direction.

In this embodiment of this application, an obstacle exists in the virtual scene, and when the virtual object moves along the first moving direction in the virtual scene, the obstacle may affect the movement of the virtual object. For example, a virtual building in the virtual scene or a boundary of the virtual scene may affect the movement of the virtual object. Therefore, before the first predicted scene location is predicted based on the current display location of the virtual object on the scene interface and the first moving direction, collision detection is performed on the current display location of the virtual object on the scene interface, the first moving direction, and the environmental parameter of the virtual scene, and the first predicted scene location is predicted based on the collision result, to ensure that the obtained first predicted scene location matches an environment of the virtual scene, and ensure accuracy of the determined first predicted scene location.

In some embodiments, the environmental parameter indicates a location of the obstacle in the virtual scene and a range of the obstacle. The range of the obstacle indicates space occupied by the obstacle in the virtual scene, and the range occupied by the obstacle is a range that the virtual object cannot move to.

In some embodiments, a collision detection process includes: The terminal invokes a collision detection function to perform collision detection on the current display location of the virtual object on the scene interface, the first moving direction, and the environmental parameter of the virtual scene to obtain the collision result.

The collision detection function is configured for detecting whether the virtual object is subject to collision during movement. In some embodiments, the collision detection function is equivalent to a movement collision system. In some embodiments, the current display location of the virtual object on the scene interface, the first moving direction, and the environmental parameter of the virtual scene are stored in a movement data component. In this case, the terminal invokes the collision detection function to obtain the current display location of the virtual object on the scene interface, the first moving direction, and the environmental parameter of the virtual scene from the movement data component, and perform collision detection on obtained data to obtain the collision result.

In this embodiment of this application, the collision result is obtained by invoking the movement collision system, and a movement status of the virtual object is determined based on the collision result. When the terminal obtains a predicted scene location, or when the terminal obtains a scene location according to the moving instruction returned by the server, the terminal can invoke the movement collision system for implementation, to ensure consistency between determined collision results, and therefore ensure consistency between a display location of the virtual object and a scene location recorded by the terminal.

In some embodiments, a collision detection process includes: performing ray detection along the first moving direction based on the obstacle indicated by the environmental parameter of the virtual scene by using the current display location of the virtual object on the scene interface as a starting point, to obtain the collision result. The collision result indicates whether the virtual object is subject to collision when moving along the first moving direction, and indicates, if collision is to occur, a location that the virtual object is to reach after the collision.

In some embodiments, a process of obtaining the first predicted scene location based on the collision result includes: when the collision result indicates that no collision is to occur, determining a product of the moving speed of the virtual object and the operation duration as a displacement, and determining a location that is away from a starting point by the displacement along the first moving direction as the first predicted scene location, the starting point being the determined scene location; when the collision result indicates that collision is to occur, determining a location at which collision is to occur as the first predicted scene location; or when the collision result indicates that collision is to occur and indicates a location after the collision and an orientation after the collision, determining, as the first predicted scene location, a location to which the virtual object moves by using the location after the collision as a starting point and by using the orientation after the collision as the first moving direction.

In this embodiment of this application, the first predicted scene location is determined in different manners based on a specific status of the collision result, to ensure accuracy of the determined first predicted scene location as much as possible.

In a possible implementation, a process of displaying movement of the virtual object includes: The terminal displays, on the scene interface by using an interpolation mechanism, the virtual object gradually moving toward the first predicted scene location.

In this embodiment of this application, the terminal displays, on the scene interface by using the interpolation mechanism, the virtual object gradually moving toward the first predicted scene location, to avoid a sudden change in a display location of the virtual object on the scene interface, so that a picture of the virtual object moving toward the first predicted scene location is smoothly displayed on the scene interface.

For example, based on the current display location of the virtual object on the scene interface and the first predicted scene location, a plurality of locations between the display location and the first predicted scene location are determined, and the virtual object sequentially moving from the current display location to each location based on an order of the plurality of locations and the first predicted scene location is displayed on the scene interface, to ensure smoothness of display of the scene interface.

In a possible implementation, the terminal displaying, on the scene interface in response to the first moving operation, the virtual object moving toward the first predicted scene location can present an idle/running animation of the virtual object on the scene interface. To be specific, the user triggers the first moving operation by using the terminal, and the terminal can display, on the scene interface, the virtual object entering a running state or a walking state from an idle state, so that the terminal can display a running or walking animation of the virtual object on the scene interface.

403: The terminal transmits a second moving request to the server in response to a second moving operation on the virtual object, the second moving request carrying a second moving direction, and the second moving direction being a moving direction of the second moving operation.

In this embodiment of this application, the terminal can transmit the first moving request to the server in response to the first moving operation on the virtual object, and display movement of the virtual object on the scene interface in a timely manner. Then, regardless of whether a moving instruction returned by the server for the first moving request is received, when detecting the second moving operation on the virtual object, the terminal can also transmit the second moving request to the server, and display movement of the virtual object on the scene interface in a timely manner, to ensure that the terminal can respond to the moving operation in a timely manner. In this way, the terminal can display a picture of movement of the virtual object on the scene interface in a timely manner, to avoid frame freezing of the picture, ensure efficiency of human-computer interaction, and therefore improve user experience.

The first moving operation is different from the second moving operation. For example, the first moving operation and the second moving operation are two moving operations. The first moving direction may be the same as or different from the second moving direction. For example, the first moving operation is to control the virtual object to move eastward, and the second moving operation is also to control the virtual object to move eastward.

404: The terminal obtains a second predicted scene location based on a current display location of the virtual object on the scene interface and the second moving direction, and displays, on the scene interface, the virtual object moving toward the second predicted scene location, the second predicted scene location being a predicted location that the virtual object is to reach in the virtual scene under the action of the second moving operation.

In this embodiment of this application, when the terminal detects the second moving operation on the virtual object, the virtual object may have moved to the first predicted scene location, or may be moving to the first predicted scene location but has not reached the first predicted scene location. Therefore, when the terminal detects the second moving operation on the virtual object, the current display location of the virtual object on the scene interface may be the first predicted scene location, or may not be the first predicted scene location. However, a first display location is different from a second display location. The first display location is a display location of the virtual object on the scene interface when the terminal detects the second moving operation on the virtual object. The second display location is a display location of the virtual object on the scene interface when the terminal detects the first moving operation on the virtual object.

The second predicted scene location is a location obtained by the local end through prediction based on the second moving operation. In other words, the second predicted scene location is a location that is predicted by the local end and that the virtual object may reach under the action of the second moving operation.

A process of obtaining, by the terminal, the second predicted scene location based on the current display location of the virtual object on the scene interface and the second moving direction is similar to operation 402. Details are not described herein again.

In this embodiment of this application, an example in which the terminal transmits a moving request to the server in response to a moving operation is used for description. In another embodiment, operations 403 and 404 do not need to be performed, and the terminal may display, on the scene interface in another manner in response to the second moving operation on the virtual object on the scene interface, the virtual object moving toward the second predicted scene location.

405: The terminal determines a first scene location in response to a moving instruction returned by the server for the first moving request, the first scene location being a location that the virtual object is to reach in the virtual scene under the action of the first moving operation.

In a possible implementation, operation 405 includes: The terminal determines, in response to the moving instruction returned by the server for the first moving request, the first scene location based on the scene location currently recorded by the terminal and the first moving direction and the moving speed of the virtual object that are carried in the moving instruction.

In this embodiment of this application, the moving instruction returned by the server for the first moving request carries the first moving direction. To be specific, after receiving the first moving request, the server returns the moving instruction to the terminal, so that the terminal can update a recorded scene location of the virtual object in the virtual scene in response to the moving instruction, to control the virtual object. The scene location currently recorded by the terminal is a scene location of the virtual object in the virtual scene, and the currently recorded scene location may not be synchronized with the current display location of the virtual object on the scene interface.

In this embodiment of this application, in response to a moving instruction returned by the server for any moving request, the terminal determines a new scene location of the virtual object in the virtual scene and records the new scene location, to ensure accuracy of a recorded scene location. When the virtual object is controlled to move, the virtual object moves along the first moving direction at the moving speed of the virtual object with a current location in the virtual scene as a starting point. Therefore, the first scene location is determined based on the scene location currently recorded by the terminal and the first moving direction and the moving speed of the virtual object that are carried in the moving instruction, to ensure accuracy of the determined first scene location.

406: The terminal calibrates the second predicted scene location based on a difference between the first scene location and the first predicted scene location when the virtual object moves toward the second predicted scene location and the first scene location is different from the first predicted scene location, and displays, on the scene interface, the virtual object moving toward a calibrated second predicted scene location.

In this embodiment of this application, the terminal can display a picture of movement of the virtual object on the scene interface in a timely manner when detecting a moving operation on the virtual object; update a scene location recorded by the terminal after receiving a moving instruction returned by the server; and when movement of the virtual object is already displayed on the scene interface, calibrate the second predicted scene location based on the difference between the first scene location and the first predicted scene location, so that the difference between the first scene location and the first predicted scene location is offset during movement of the virtual object toward the calibrated second predicted scene location, to ensure synchronization between a scene location recorded by the terminal and a display location of the virtual object on the scene interface as much as possible, and ensure accuracy of game data.

In a possible implementation, a process of calibrating the second predicted scene location includes: determining a location offset vector based on the difference between the first scene location and the first predicted scene location, and offsetting the second predicted scene location based on the location offset vector to obtain the calibrated second predicted scene location.

In this embodiment of this application, before the terminal receives the moving instruction returned by the server for the first moving operation, the terminal has displayed movement of the virtual object on the scene interface in response to the second moving operation. However, in another embodiment, before the terminal receives the moving instruction returned by the server for the first moving operation, in addition to displaying movement of the virtual object on the scene interface in response to the second moving operation, the terminal can also display movement of the virtual object on the scene interface in response to another moving operation. This is not limited in this application.

In this embodiment of this application, before the terminal receives the moving instruction returned by the server for the first moving operation, the terminal has displayed movement of the virtual object on the scene interface in response to the second moving operation. However, in another embodiment, operations 403 and 404 and operation 406 do not need to be performed, and a display location of the virtual object on the scene interface is calibrated based on the first scene location in another manner when the first scene location is different from the first predicted scene location.

In this embodiment of this application, the terminal predicts, in response to the first moving operation, the first predicted scene location that the virtual object may reach in the virtual scene under the action of the first moving operation; displays, on the scene interface, the virtual object moving toward the first predicted scene location obtained through prediction; and then determines the first scene location of the virtual object in the virtual scene according to the moving instruction returned by the server, compares the determined first scene location with the first predicted scene location, and calibrates the display location of the virtual object on the scene interface when the first predicted scene location obtained through prediction is inaccurate. In this way, the display location of the virtual object on the scene interface is synchronized, as much as possible, with the scene location that the virtual object is to reach in the virtual scene, to ensure accuracy of the display location of the virtual object on the scene interface. In addition, the terminal can respond to the first moving operation in a timely manner without waiting for a long time for the moving instruction delivered by the server, to avoid a delay in responding to the moving operation, so that the terminal can display a picture of movement of the virtual object on the scene interface in a timely manner. This avoids frame freezing of the picture displayed by the terminal, and therefore can improve user experience.

In addition, in this embodiment of this application, a pre-presentation mechanism is used. Each time the terminal detects a moving operation on the virtual object, the terminal can display movement of the virtual object on the scene interface in a timely manner, to drive proceeding of a local game on the terminal. In this way, the terminal responds to the moving operation in a timely manner, and then calibrates a display location of the virtual object after receiving a corresponding instruction returned by the server for the moving operation. This implements a pre-display manner. A scene location recorded by the terminal lags behind a display location of the virtual object on the scene interface. This can ensure that the terminal can respond in a timely manner to mitigate negative impact caused by a network delay and increase a speed of responding to a moving operation, and can also optimize manipulation hand feel in a high-delay network environment to game experience of a user in a poor network environment. In addition, when receiving a moving instruction delivered by the server, the terminal can calibrate a display location of the virtual object on the scene interface in a rollback or interpolation manner, to ensure accuracy of game data.

In the embodiment shown in FIG. 4, the terminal detecting the second moving operation is equivalent to the terminal no longer detecting the first moving operation. To be specific, the virtual object does not need to be controlled to move toward the first moving direction. However, in another embodiment, when detecting the first moving operation, the terminal transmits a displacement stop notification to the server in response to detecting a stop operation, and displays, on the scene interface, the virtual object stopping moving. The server transmits, based on the displacement stop notification, a displacement stop notification to terminals participating in a same game. The terminal receives the displacement stop notification transmitted by the server, and determines the first scene location according to the moving instruction returned for the first moving operation and the displacement stop notification. For example, the terminal determines operation duration corresponding to the first moving operation based on a difference between time at which the moving instruction is received and time at which the displacement stop notification is received, and determines the first scene location based on the operation duration, the first moving direction, and the moving speed of the virtual object. The moving instruction is returned by the server for the first moving operation.

Based on the embodiments shown in FIG. 3 and FIG. 4, in an embodiment of this application, if duration of the first moving operation is long, the terminal can predict a first predicted scene location at an internal of a time step in response to the first moving operation, and display the virtual object moving toward the predicted scene location. To be specific, a process of obtaining the first predicted scene location and displaying, on the scene interface, the virtual object moving toward the first predicted scene location includes: obtaining an i^{th} first predicted scene location based on a scene location corresponding to a display location in the virtual scene, the first moving direction, and the time step; displaying, on the scene interface, the virtual object moving toward the i^{th} first predicted scene location, i being an integer greater than 0; obtaining an (i+1)^{th} first predicted scene location based on the i^{th} first predicted scene location, the first moving direction, and the time step; and when the virtual object has moved to the i^{th} first predicted scene location, displaying, on the scene interface, the virtual object moving toward the (i+1)^{th} first predicted scene location.

The time step is any duration. For example, the time step is 5 seconds or 2 seconds.

In this embodiment of this application, the first moving operation is a long-time moving operation, for example, the first moving operation is an operation, triggered by the user, of moving eastward for a long time. Therefore, with the time step as a measurement unit, a first predicted scene location is predicted at an interval of the time step, and the virtual object moving toward the first predicted scene location is displayed on the scene interface. Then a next first predicted scene location is predicted. In this way, the virtual object gradually moves along the first moving direction under the action of the first moving operation, so that the terminal can respond in a timely manner when continuously detecting the first moving operation, to avoid frame freezing of a picture caused by displaying movement of the virtual object only when the first moving operation is no longer detected. This ensures continuity of movement of the virtual object, and can also ensure accuracy of movement of the virtual object along the first moving direction.

Then a first predicted scene location is predicted for a plurality of times according to the foregoing process, and the virtual object moving toward a predicted scene location obtained through prediction is displayed until the first moving operation is no longer detected. That the first moving operation is no longer detected means that another moving operation different from the first moving direction is detected, or no moving operation is detected, or a skill release operation on the virtual object is detected, or the like.

In the foregoing process, when the first moving operation is no longer detected and remaining operation duration is less than the time step, an n^{th} first predicted scene location is obtained based on an (n−1)^{th} first predicted scene location, the first moving direction, and the remaining operation duration; and when the virtual object has moved to the (n−1)^{th} first predicted scene location, the virtual object moving toward the n^{th} first predicted scene location is displayed on the scene interface. n is an integer greater than 1. For example, the operation duration of the first moving operation is greater than n−1 times of the time step but is less than n times of the time step. To be specific, in a process of detecting the first moving operation, the 1^{st} first predicted scene location is determined in the foregoing manner, and the virtual object moving toward the 1^{st} first predicted scene location is displayed on the scene interface; the 2^{nd} first predicted scene location is obtained based on the 1^{st} first predicted scene location, the first moving direction, and the time step; when the virtual object has moved to the 1^{st} first predicted scene location, the virtual object moving toward the 2^{nd} first predicted scene location is displayed on the scene interface; the (n−1)^{th} first predicted scene location can be obtained by repeating the foregoing steps; the virtual object moving toward the (n−1)^{th} first predicted scene location is displayed on the scene interface; in this case, remaining operation duration is a difference between the operation duration of the first moving operation and n−1 times of the time step, and the n^{th} first predicted scene location is obtained based on the (n−1)^{th} first predicted scene location, the first moving direction, and the remaining operation duration; and when the virtual object has moved to the (n−1)^{th} first predicted scene location, the virtual object moving toward the n^{th} first predicted scene location is displayed on the scene interface.

In this embodiment of this application, when displaying movement of the virtual object on the scene interface in response to the first moving operation, the terminal can display gradual movement of the virtual object on the scene interface by predicting n first predicted scene locations. The first scene location is a scene location that is determined by the terminal in response to the moving instruction and that needs to be recorded, and the scene location does not need to be determined based on the time step. Therefore, when this embodiment of this application is combined with the embodiment shown in FIG. 3 or FIG. 4, an example in which n first predicted scene locations are obtained is used. After the first scene location is obtained, the first scene location is compared with the n^{th} first predicted scene location. When the first scene location is different from the first predicted scene location, a display location of the virtual object on the scene interface is calibrated based on the first scene location.

Based on the embodiments shown in FIG. 3 and FIG. 4, in an embodiment of this application, if duration of the first moving operation is long, the terminal transmits a moving request to the server at an interval of a time step in response to the first moving operation, and each time the terminal transmits a moving request to the server, the terminal predicts a predicted scene location, and displays, on the scene interface, the virtual object moving toward the predicted scene location. To be specific, a process of transmitting, by the terminal, a moving request to the server for a plurality of times in response to the first moving operation, and displaying movement of the virtual object includes: The terminal transmits a first moving request to the server at an interval of the time step in response to the first moving operation. After transmitting the 1^{st} first moving request to the server, the terminal obtains the 1^{st} first predicted scene location based on a scene location that is in the virtual scene and that corresponds to a current display location of the virtual object on the scene interface, the first moving direction, and the time step; and displays, on the scene interface, the virtual object moving toward the 1^{st} first predicted scene location. After transmitting a j^{th} first moving request to the server, the terminal obtains a j^{th} first predicted scene location based on a (j−1)^{th} first predicted scene location, the first moving direction, and the time step; and when the virtual object has moved to the (j−1)^{th} first predicted scene location, displays, on the scene interface, the virtual object moving toward the j^{th} first predicted scene location, j being an integer greater than 1.

In this embodiment of this application, a process of predicting, by the terminal, a predicted scene location each time after transmitting a moving request to the server, and displaying, on the scene interface, the virtual object moving toward the predicted scene location is similar to the foregoing process of predicting, by the terminal, a first predicted scene location at an interval of the time step in response to the first moving operation, and displaying the virtual object moving toward the predicted scene location. Details are not described herein again.

In this embodiment of this application, because the first moving operation is a long-time moving operation, the terminal transmits a moving request to the server at an interval of the time step in response to the first moving operation, and each time the terminal transmits a moving request to the server, the terminal predicts a predicted scene location, and displays, on the scene interface, the virtual object moving toward the predicted scene location. In this way, the virtual object gradually moves along the first moving direction under the action of the first moving operation, so that the terminal can respond in a timely manner when continuously detecting the first moving operation, to avoid frame freezing of a picture caused by displaying movement of the virtual object only when the first moving operation is no longer detected. This ensures continuity of movement of the virtual object, and can also ensure accuracy of movement of the virtual object along the first moving direction.

Based on the embodiment shown in FIG. 3, in an embodiment of this application, when the terminal receives the moving instruction returned by the server for the first moving operation, the terminal has transmitted a plurality of moving requests to the server in response to a plurality of moving operations on the virtual object on the scene interface and controlled the virtual object to move. For a specific process, refer to the following embodiment.

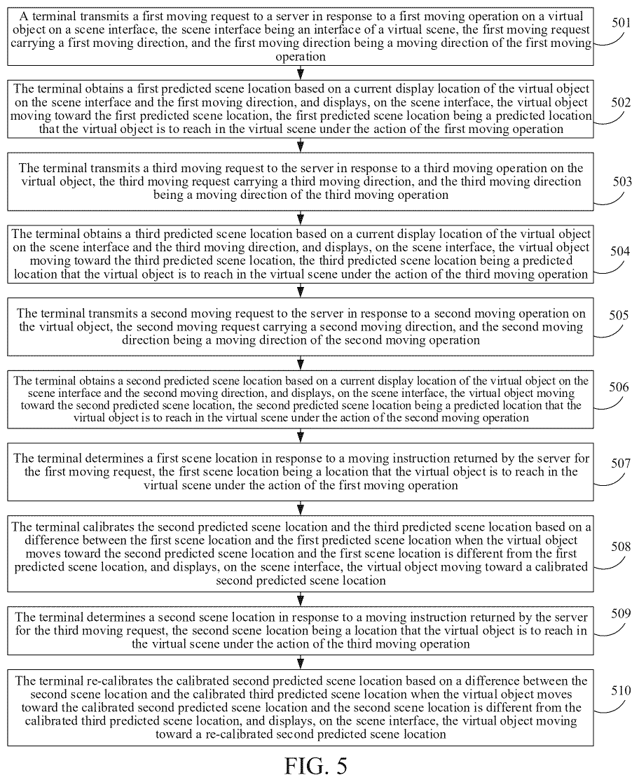

FIG. 5 is a flowchart of a virtual object control method according to an embodiment of this application. For example, the method is performed by a terminal. As shown in FIG. 5, the method includes the following operations:

501: The terminal transmits a first moving request to a server in response to a first moving operation on a virtual object on a scene interface, the scene interface being an interface of a virtual scene, the first moving request carrying a first moving direction, and the first moving direction being a moving direction of the first moving operation.

502: The terminal obtains a first predicted scene location based on a current display location of the virtual object on the scene interface and the first moving direction, and displays, on the scene interface, the virtual object moving toward the first predicted scene location, the first predicted scene location being a predicted location that the virtual object is to reach in the virtual scene under the action of the first moving operation.

Operations 501 and 502 are similar to operations 401 and 402. Details are not described herein again.

503: The terminal transmits a third moving request to the server in response to a third moving operation on the virtual object, the third moving request carrying a third moving direction, and the third moving direction being a moving direction of the third moving operation.

Operation 503 is similar to operation 403. Details are not described herein again.

504: The terminal obtains a third predicted scene location based on a current display location of the virtual object on the scene interface and the third moving direction, and displays, on the scene interface, the virtual object moving toward the third predicted scene location, the third predicted scene location being a predicted location that the virtual object is to reach in the virtual scene under the action of the third moving operation.

In this embodiment of this application, when the terminal detects the third moving operation on the virtual object, the virtual object may have moved to the first predicted scene location, or may be moving to the first predicted scene location but has not reached the first predicted scene location. Therefore, when the terminal detects the third moving operation on the virtual object, the current display location of the virtual object on the scene interface may be the first predicted scene location, or may not be the first predicted scene location. However, a second display location is different from a third display location. The third display location is a display location of the virtual object on the scene interface when the terminal detects the third moving operation on the virtual object. The second display location is a display location of the virtual object on the scene interface when the terminal detects the first moving operation on the virtual object.

The third predicted scene location is a location obtained by a local end through prediction based on the third moving operation. In other words, the third predicted scene location is a location that is predicted by the local end and that the virtual object may reach under the action of the third moving operation.

A process of obtaining, by the terminal, the third predicted scene location based on the current display location of the virtual object on the scene interface and the third moving direction is similar to operation 402. Details are not described herein again.

In this embodiment of this application, an example in which the terminal transmits a moving request to the server in response to a moving operation is used for description. In another embodiment, operations 503 and 504 do not need to be performed, and the terminal may display, on the scene interface in another manner in response to the third moving operation on the virtual object on the scene interface, the virtual object moving toward the third predicted scene location.

505: The terminal transmits a second moving request to the server in response to a second moving operation on the virtual object, the second moving request carrying a second moving direction, and the second moving direction being a moving direction of the second moving operation.

506: The terminal obtains a second predicted scene location based on a current display location of the virtual object on the scene interface and the second moving direction, and displays, on the scene interface, the virtual object moving toward the second predicted scene location, the second predicted scene location being a predicted location that the virtual object is to reach in the virtual scene under the action of the second moving operation.

Operations 505 and 506 are similar to operations 403 and 404. Details are not described herein again.

507: The terminal determines a first scene location in response to a moving instruction returned by the server for the first moving request, the first scene location being a location that the virtual object is to reach in the virtual scene under the action of the first moving operation.

Operation 507 is similar to operation 405. Details are not described herein again.

508: The terminal calibrates the second predicted scene location and the third predicted scene location based on a difference between the first scene location and the first predicted scene location when the virtual object moves toward the second predicted scene location and the first scene location is different from the first predicted scene location, and displays, on the scene interface, the virtual object moving toward a calibrated second predicted scene location.

In this embodiment of this application, the terminal can display movement of the virtual object on the scene interface in a timely manner when detecting a moving operation on the virtual object; update a scene location recorded by the terminal after receiving a moving instruction returned by the server; and when movement of the virtual object is already displayed on the scene interface, calibrate the second predicted scene location and the third predicted scene location based on the difference between the first scene location and the first predicted scene location. In this way, the difference between the first scene location and the first predicted scene location is offset during movement of the virtual object toward the calibrated second predicted scene location, and it is ensured that the difference between the first scene location and the first predicted scene location is offset at a calibrated third predicted scene location, to ensure synchronization between a scene location recorded by the terminal and a display location of the virtual object on the scene interface as much as possible, ensure accuracy of a predicted scene location, and ensure accuracy of game data.

A process of calibrating the second predicted scene location and the third predicted scene location is similar to the process of calibrating the second predicted scene location in operation 406. Details are not described herein again.

In a possible implementation, the terminal stores a predicted scene location, to be specific, the terminal stores the first predicted scene location, the second predicted scene location, and the third predicted scene location. In this case, the method further includes: The terminal calibrates the second predicted scene location and the third predicted scene location based on the difference between the first scene location and the first predicted scene location when the virtual object moves toward the second predicted scene location and the first scene location is different from the first predicted scene location, and stores the calibrated second predicted scene location and the calibrated third predicted scene location.

In this embodiment of this application, the terminal stores a predicted scene location obtained through prediction, to subsequently compare the stored predicted scene location with a scene location obtained by the terminal according to a moving instruction, and calibrate a display location of the virtual object on the scene interface when the predicted scene location is different from the scene location obtained by the terminal according to the moving instruction. In addition, when a stored predicted scene location is calibrated, a calibrated predicted scene location is stored, to ensure accuracy of a stored predicted scene location, and ensure that, after the server subsequently returns a moving instruction for a moving request corresponding to the calibrated predicted scene location, the terminal obtains a new scene location according to the moving instruction, and compares the calibrated predicted scene location with the new scene location, to ensure accuracy of a display location of the virtual object.

In some embodiments, the terminal stores the first predicted scene location, the second predicted scene location, and the third predicted scene location in a predicted scene location queue, and when the second predicted scene location and the third predicted scene location are calibrated, stores the calibrated second predicted scene location and the calibrated third predicted scene location in the predicted scene location queue.

In some embodiments, the first predicted scene location, the second predicted scene location, and the third predicted scene location are deleted when the calibrated second predicted scene location and the calibrated third predicted scene location are stored.

In this embodiment of this application, after a subsequently obtained predicted scene location is calibrated based on the first predicted scene location, the first predicted scene location does not need to exist. In addition, the second predicted scene location and the third scene location are calibrated. Therefore, the first predicted scene location, the second predicted scene location, and the third predicted scene location are deleted, to save storage space.

In this embodiment of this application, before the terminal receives the moving instruction returned by the server for the first moving operation, the terminal has displayed movement of the virtual object on the scene interface in response to the third moving operation and the second moving operation. However, in another embodiment, operations 503 to 506 and operation 508 do not need to be performed, and a display location of the virtual object on the scene interface is calibrated based on the first scene location in another manner when the first scene location is different from the first predicted scene location.

509: The terminal determines a second scene location in response to a moving instruction returned by the server for the third moving request, the second scene location being a location that the virtual object is to reach in the virtual scene under the action of the third moving operation.

Operation 509 is similar to operation 405. Details are not described herein again.

510: The terminal re-calibrates the calibrated second predicted scene location based on a difference between the second scene location and the calibrated third predicted scene location when the virtual object moves toward the calibrated second predicted scene location and the second scene location is different from the calibrated third predicted scene location, and displays, on the scene interface, the virtual object moving toward a re-calibrated second predicted scene location.

In this embodiment of this application, the third predicted scene location is obtained through prediction based on the first predicted scene location, and the difference between the first scene location and the first predicted scene location is offset at the calibrated third predicted scene location. Therefore, the second scene location is compared with the calibrated third predicted scene location to determine whether a current display location of the virtual object on the scene interface further needs to be calibrated. The calibrated second predicted scene location is re-calibrated based on the difference between the second scene location and the calibrated third predicted scene location when the virtual object moves toward the calibrated second predicted scene location and the second scene location is different from the calibrated third predicted scene location, to offset the difference between the first scene location and the first predicted scene location and the difference between the second scene location and the calibrated third predicted scene location during movement of the virtual object toward the re-calibrated second predicted scene location. This ensures that the difference between the first scene location and the first predicted scene location and the difference between the second scene location and the calibrated third predicted scene location are offset at the re-calibrated second predicted scene location, to ensure synchronization between a scene location recorded by the terminal and a display location of the virtual object on the scene interface as much as possible, ensure accuracy of a predicted scene location, and ensure accuracy of game data.

As shown in FIG. 6, the terminal displays movement of the virtual object on the scene interface in response to the first moving operation, two third moving operations, and the second moving operation. In this case, predicted scene locations in the predicted scene location queue include S1, S2, S3, and S4. S1 is the first predicted scene location, S2 and S3 are two third predicted scene locations obtained through the two third moving operations, and S4 is the second predicted scene location. The terminal determines the first scene location L1 in response to the moving instruction returned by the server for the first moving request, calibrates S2, S3, and S4 based on a difference between L1 and S1 to obtain S2′, S3′, and S4′, and stores S2′, S3′, and S4′ in the predicted scene location queue. After determining the second scene location in response to the moving instruction returned by the server for the third moving request, the terminal calibrates S3 ‘and S4’ based on a difference between the second scene location and S2′, and then stores calibrated S3′ and S4′ in the predicted scene location queue.

In this embodiment of this application, the moving instruction returned by the server for the third moving request is received during movement of the virtual object toward the calibrated second predicted scene location. However, in another embodiment, operations 509 and 510 do not need to be performed, and only movement of the virtual object toward the calibrated second predicted scene location is displayed on the scene interface.

In this embodiment of this application, the terminal predicts, in response to the first moving operation, the first predicted scene location that the virtual object may reach in the virtual scene under the action of the first moving operation; displays, on the scene interface, the virtual object moving toward the first predicted scene location obtained through prediction; and then determines the first scene location of the virtual object in the virtual scene according to the moving instruction returned by the server, compares the determined first scene location with the first predicted scene location, and calibrates the display location of the virtual object on the scene interface when the first predicted scene location obtained through prediction is inaccurate. In this way, the display location of the virtual object on the scene interface is synchronized, as much as possible, with the scene location that the virtual object is to reach in the virtual scene, to ensure accuracy of the display location of the virtual object on the scene interface. In addition, the terminal can respond to the first moving operation in a timely manner without waiting for a long time for the moving instruction delivered by the server, to avoid a delay in responding to the moving operation, so that the terminal can display a picture of movement of the virtual object on the scene interface in a timely manner. This avoids frame freezing of the picture displayed by the terminal, and therefore can improve user experience.

In this embodiment of this application, the terminal can display movement of the virtual object on the scene interface in a timely manner when detecting a moving operation on the virtual object; update a scene location recorded by the terminal after receiving a moving instruction returned by the server; and when movement of the virtual object is already displayed on the scene interface, calibrate the second predicted scene location and the third predicted scene location based on the difference between the first scene location and the first predicted scene location. In this way, the difference between the first scene location and the first predicted scene location is offset during movement of the virtual object toward the calibrated second predicted scene location, and it is ensured that the difference between the first scene location and the first predicted scene location is offset at a calibrated third predicted scene location, to ensure synchronization between a scene location recorded by the terminal and a display location of the virtual object on the scene interface as much as possible, ensure accuracy of a predicted scene location, and ensure accuracy of game data.

Based on the embodiment shown in FIG. 2, in an embodiment of this application, when the terminal receives the moving instruction returned by the server for the first moving operation, on the scene interface, the virtual object may be moving toward the first predicted scene location, or the virtual object has moved to the first predicted scene location and is in an idle state. In this case, the virtual object is controlled to move toward the first scene location, to ensure that a display location is synchronized with a scene location. For a specific process, refer to the following embodiment.

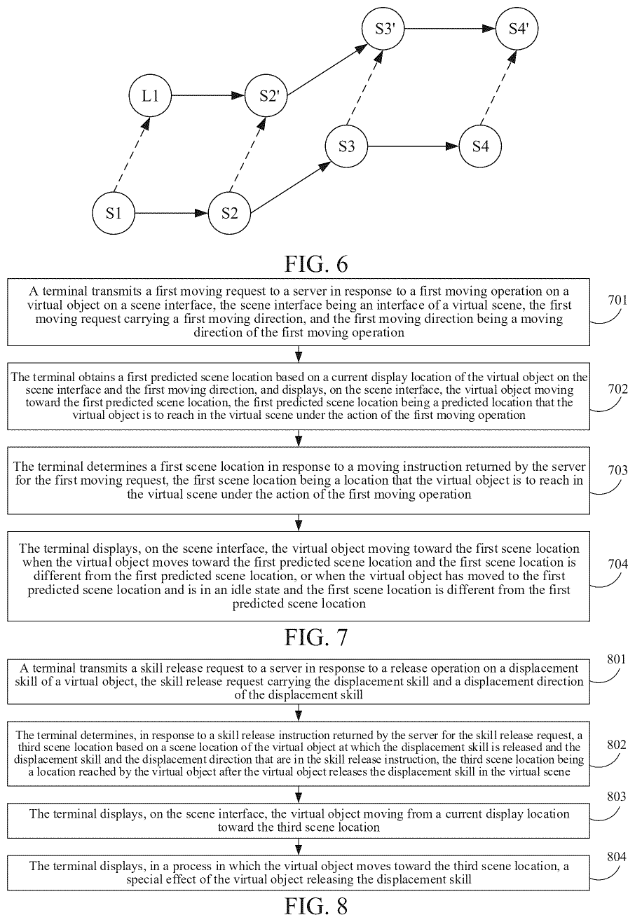

FIG. 7 is a flowchart of a virtual object control method according to an embodiment of this application. For example, the method is performed by a terminal. As shown in FIG. 7, the method includes the following operations:

701: The terminal transmits a first moving request to a server in response to a first moving operation on a virtual object on a scene interface, the scene interface being an interface of a virtual scene, the first moving request carrying a first moving direction, and the first moving direction being a moving direction of the first moving operation.

702: The terminal obtains a first predicted scene location based on a current display location of the virtual object on the scene interface and the first moving direction, and displays, on the scene interface, the virtual object moving toward the first predicted scene location, the first predicted scene location being a predicted location that the virtual object is to reach in the virtual scene under the action of the first moving operation.

703: The terminal determines a first scene location in response to a moving instruction returned by the server for the first moving request, the first scene location being a location that the virtual object is to reach in the virtual scene under the action of the first moving operation.

Operations 701 to 703 are similar to operations 301 to 303. Details are not described herein again.

704: The terminal displays, on the scene interface, the virtual object moving toward the first scene location when the virtual object moves toward the first predicted scene location and the first scene location is different from the first predicted scene location, or when the virtual object has moved to the first predicted scene location and is in an idle state and the first scene location is different from the first predicted scene location.

In this embodiment of this application, when the terminal receives the moving instruction returned by the server for the first moving request, the virtual object is moving toward the first predicted scene location but has not moved to the first predicted scene location, which indicates that the terminal displays, on the scene interface, the virtual object being responding to the first moving operation but having not completed responding; or the virtual object has moved to the first predicted scene location and is in the idle state, which indicates that the terminal has completed responding to the first moving operation. Therefore, determining that the first scene location is different from the first predicted scene location indicates that the first predicted scene location toward which the virtual object is moving is inaccurate, or the first predicted scene location at which the virtual object is currently located is inaccurate. Therefore, the first scene location is directly considered as a location that the virtual object needs to reach. In this case, the virtual object moving toward the first scene location is displayed, to ensure that a display location of the virtual object on the scene interface is consistent with a scene location as much as possible, and further ensure accuracy of game data.

In this embodiment of this application, an example in which the terminal detects only the first moving operation is used for description. However, in another embodiment, operation 704 does not need to be performed, and a display location of the virtual object on the scene interface is calibrated based on the first scene location in another manner when the first scene location is different from the first predicted scene location.

In this embodiment of this application, the terminal predicts, in response to the first moving operation, the first predicted scene location that the virtual object may reach in the virtual scene under the action of the first moving operation; displays, on the scene interface, the virtual object moving toward the first predicted scene location obtained through prediction; and then determines the first scene location of the virtual object in the virtual scene according to the moving instruction returned by the server, compares the determined first scene location with the first predicted scene location, and calibrates the display location of the virtual object on the scene interface when the first predicted scene location obtained through prediction is inaccurate. In this way, the display location of the virtual object on the scene interface is synchronized, as much as possible, with the scene location that the virtual object is to reach in the virtual scene, to ensure accuracy of the display location of the virtual object on the scene interface. In addition, the terminal can respond to the first moving operation in a timely manner without waiting for a long time for the moving instruction delivered by the server, to avoid a delay in responding to the moving operation, so that the terminal can display a picture of movement of the virtual object on the scene interface in a timely manner. This avoids frame freezing of the picture displayed by the terminal, and therefore can improve user experience.

In this embodiment of this application, determining that the first scene location is different from the first predicted scene location indicates that the first predicted scene location toward which the virtual object is moving is inaccurate, or the first predicted scene location at which the virtual object is currently located is inaccurate. Therefore, the first scene location is directly considered as a location that the virtual object needs to reach. In this case, the virtual object moving toward the first scene location is displayed, to ensure that a display location of the virtual object on the scene interface is consistent with a scene location as much as possible, and further ensure accuracy of game data.

Based on the embodiments shown in FIG. 2 to FIG. 7, the terminal includes a presentation layer and a logic layer. The terminal displays a virtual object on a scene interface through the presentation layer, and can display movement of the virtual object on the scene interface. The terminal can record a scene location of the virtual object in a virtual scene through the logic layer, the scene location being equivalent to a logical location recorded by the logic layer, so that the terminal calibrates a display location of the virtual object on the scene interface through the presentation layer by using the scene location, the display location being equivalent to a presentation location at which the virtual object is displayed by the presentation layer. When the terminal displays the scene interface, a user can trigger a moving operation on the virtual object on the scene interface displayed by the terminal. After detecting the moving operation, the terminal not only transmits a moving request to the server, but also obtains a predicted scene location through the presentation layer in a manner shown in the foregoing embodiments; and displays, on the scene interface based on a moving direction and a moving speed of the virtual object, the virtual object moving toward the predicted scene location. Then the terminal determines a scene location of the virtual object in the virtual scene through the logic layer in response to a moving instruction returned by the server for the moving request; and when the scene location is different from the predicted scene location, calibrates a display location of the virtual object on the scene interface through the presentation layer based on the scene location, so that the display location of the virtual object on the scene interface at the presentation layer is the same as the scene location of the virtual object in the virtual scene at the logic layer.

In an ideal case, the user triggers a moving operation by using the terminal to control the virtual object to move in the virtual scene, no packet loss occurs during interaction between the terminal and the server, and a frame rate of the presentation layer of the terminal is the same as a frame rate of the logic layer. In this case, the terminal executes a same moving instruction through the logic layer and the presentation layer. Movement at the logic layer is later than movement at the presentation layer merely due to a network delay. However, a scene location finally obtained through the logic layer is the same as a display location finally obtained through the presentation layer, to ensure accuracy of a display location of the virtual object displayed on the scene interface and ensure accuracy of game data. In this embodiment of this application, for a same virtual object, scene locations of the virtual object in a virtual scene that are recorded by a plurality of terminals participating in a same round of game are the same.

However, in an actual case, a scene location determined by the terminal may be different from a predicted scene location due to the following three causes:

A first cause lies in a connection between a moving operation and a skill release operation. In a game, a virtual object may be prohibited from moving when the virtual object is releasing a skill. In this embodiment of this application, the terminal responds to a moving operation through the presentation layer, to control the virtual object to move in the virtual scene; and the terminal responds, through the logic layer, to a moving instruction returned by the server, to update a display location of the virtual object. Because no pre-presentation mechanism is applied to skill release by the virtual object but a pre-presentation mechanism is applied to a moving operation on the virtual object, in a process of displaying movement of the virtual object on the scene interface by using the pre-presentation mechanism, the terminal transmits a skill release request to the server in response to a skill release operation on the virtual object. When the terminal has not received a skill release instruction returned by the server for the skill release request, the terminal detects a moving operation on the virtual object through the presentation layer, and displays movement of the virtual object on the scene interface in the foregoing manner. When the terminal receives, through the logic layer, a skill release instruction returned by the server for the skill release request, the virtual object is in a movement-prohibited state, and skill release by the virtual object is displayed on the scene interface. When the virtual object is in the movement-prohibited state, the terminal only transmits a moving request to the server in response to a moving operation on the virtual object on the scene interface, but no longer controls the virtual object to move based on the moving operation. In addition, because a moving instruction returned by the server for a moving request lags, when the virtual object is in the movement-prohibited state, the terminal may receive a moving instruction returned by the server for a target moving request. However, the terminal does not respond, through the logic layer, to the moving instruction corresponding to the target moving request. The target moving request is a moving request transmitted to the server before the skill release operation is triggered on the virtual object. However, the terminal has responded, through the presentation layer, to a moving operation corresponding to the target moving request. In this case, when the virtual object is in the “movement-prohibited state”, a moving operation to which the presentation layer is prohibited from responding may be different from a moving operation to which the logic layer is prohibited from responding. In an entire movement and skill connection process, a moving operation performed in a pre-presentation manner is also different from a moving operation performed by the logic layer. Consequently, a scene location determined by using the logic layer is different from a predicted scene location determined by using the presentation layer.

A second cause lies in a difference between a frame rate at the presentation layer and a frame rate at the logic layer. For a frame synchronized game, the server is configured to forward a moving request transmitted by the terminal only to a terminal participating in a same game, and the terminal implements calculation in the game. A logic frame update interval is fixed. Assuming that a logic frame rate is 15 frames, regardless of how a presentation frame rate of the terminal changes, a logic update interval of the terminal is fixed duration. The presentation frame rate is variable in different game scenes and at different moments. Even if the user does not trigger any operation by using the terminal, the presentation frame rate still fluctuates. In addition, due to network fluctuation, a quantity of presentation frame updates corresponding to each logic frame is not fixed either. Consequently, cumulative update intervals of all presentation frames corresponding to a same logic frame are different, and at a same moving speed, a displacement distance of a character at the presentation layer and a displacement distance of the character at the logic layer are different. In this embodiment of this application, a location of the virtual object in each frame is determined in a per-frame determining manner at both the presentation layer and the logic layer. Because the frame rate at the presentation layer is different from the frame rate at the logic layer, each frame corresponding to the presentation layer is not in a one-to-one correspondence with each frame corresponding to the logic layer. To be specific, a game moment corresponding to the frame corresponding to the presentation layer is inconsistent with a game moment corresponding to the frame corresponding to the logic layer. Therefore, for a same moving operation, when the moving operation ends, a display location of the virtual object that is determined by the presentation layer is different from a scene location of the virtual object that is determined by the logic layer. Consequently, a scene location determined by the terminal may be different from a predicted scene location.

A third cause lies in network packet loss. Network packet loss is a common issue during network communication. For a frame synchronized game, to ensure consistency between frame commands received by different clients from the server, a retransmission mechanism is usually used to ensure that downlink transmission from the server to the client is always reliable. Network packet loss may occur during interaction between the terminal and the server. The server receiving no first moving request transmitted by the terminal indicates that the first moving request encounters packet loss. Consequently, the first scene location determined by the terminal is different from the first predicted scene location.

Therefore, according to the solutions provided in the embodiments of this application, the pre-presentation mechanism can be used, to enable the terminal to pre-display movement of the virtual object on the scene interface, and a display location of the virtual object on the scene interface can also be calibrated after a scene location is determined. This not only ensures accuracy of game data, but also enables the terminal to respond to the first moving operation in a timely manner without waiting for a long time for the moving instruction delivered by the server, to avoid a delay in responding to the moving operation, so that the terminal can display a picture of movement of the virtual object on the scene interface in a timely manner. This avoids frame freezing of the picture displayed by the terminal, and therefore can improve user experience.

Based on the embodiments shown in FIG. 2 to FIG. 7, in an embodiment of this application, a release operation on a displacement skill of a virtual object can be further triggered, to display, on a scene interface, the virtual object moving toward a landing point of the displacement skill. For a specific process, refer to the following embodiment.

FIG. 8 is a flowchart of a virtual object control method according to an embodiment of this application. For example, the method is performed by a terminal. As shown in FIG. 8, the method includes the following operations:

801: The terminal transmits a skill release request to a server in response to a release operation on a displacement skill of a virtual object, the skill release request carrying the displacement skill and a displacement direction of the displacement skill.

In this embodiment of this application, on a scene interface displayed by the terminal, a user not only can trigger a moving operation on the virtual object, but also can trigger the release operation on the displacement skill of the virtual object, to control the virtual object to move.

The displacement skill is a skill that can cause a displacement of the virtual object. For example, any displacement skill causes the virtual object to jump forward by a first distance, or cause the virtual object to sprint forward by a first distance, or cause the virtual object to roll to the left by a second distance. Both the first distance and the second distance are any distances. The release operation on the displacement skill indicates that the user wants to control, on the scene interface displayed by the terminal, the virtual object to release the displacement skill in a virtual scene.

In a possible implementation, the displacement direction of the displacement skill is a fixed direction relative to the virtual object, or is determined based on the triggered release operation.

In this embodiment of this application, the displacement direction of the displacement skill is a fixed direction relative to the virtual object. For example, the displacement direction of the displacement skill is toward the direct front of the virtual object or toward the left of the virtual object. However, when a moving direction of virtual displacement is determined based on a release operation, the displacement direction of the displacement skill is selected by the user when the user triggers the release operation on the displacement skill on the scene interface displayed by the terminal, that is, a direction toward which the user wants the virtual object to release the displacement skill.

In a possible implementation, an option for the displacement skill of the virtual object is displayed on the scene interface, and the terminal detecting a trigger operation on the option for the displacement skill is equivalent to detecting a release operation on the displacement skill.

In some embodiments, operation 801 includes: displaying a direction guide sign on the scene interface in response to a press operation on the option for the displacement skill, the direction guide sign indicating the displacement direction of the displacement skill; and transmitting a skill release request to the server in response to a release operation on the option for the displacement skill, the skill release request carrying the displacement skill and a displacement direction indicated by a direction guide sign that is displayed when the release operation is detected.

802: The terminal determines, in response to a skill release instruction returned by the server for the skill release request, a third scene location based on a scene location of the virtual object at which the displacement skill is released and the displacement skill and the displacement direction that are in the skill release instruction, the third scene location being a location reached by the virtual object after the virtual object releases the displacement skill in the virtual scene.

In this embodiment of this application, the scene location of the virtual object at which the displacement skill is released is a scene location, recorded by the terminal, of the virtual object in the virtual scene. The displacement skill in the skill release instruction can be represented in any form. For example, the skill release instruction carries a skill identifier, and the terminal may determine a corresponding displacement skill based on the skill identifier. A displacement that is to occur when the virtual object releases the displacement skill in the virtual scene may be determined based on the displacement skill in the skill release instruction. In this case, a location that the virtual object reaches after moving along the displacement direction by the displacement produced by the displacement skill, with the scene location of the virtual object at which the displacement skill is released as a starting point, is the third scene location. The terminal records the scene displacement.

803: The terminal displays, on the scene interface, the virtual object moving from a current display location toward the third scene location.

In this embodiment of this application, when controlling, by using the terminal, the virtual object to release the displacement skill in the virtual scene, the user has a high requirement for a location that the virtual object reaches after the displacement skill is released, to ensure precision of skill release, and ensure that the virtual object releases the displacement skill to reach the third scene location. Therefore, regardless of whether the virtual object is currently in an idle state or is heading to a predicted scene location, when the third scene location is determined, the virtual object is immediately controlled to gradually move from a current display location to the third scene location, so that the virtual object moves to the third scene location, to ensure accuracy of skill release.

804: The terminal displays, in a process in which the virtual object moves toward the third scene location, a special effect of the virtual object releasing the displacement skill.

In this embodiment of this application, in the process in which the virtual object moves toward the third scene location, the terminal displays, on the scene interface, the special effect of the virtual object releasing the displacement skill, to enrich content displayed on the scene interface, and improve a display effect of the scene interface. The special effect of releasing the displacement skill is a special effect in any form. For example, the displacement skill indicates that the virtual object sprints forward. In this case, in the process in which the virtual object moves toward the third scene location, a special effect of the virtual object sprinting forward is displayed on the scene interface, and a sprint light-wave special effect is displayed around the virtual object, or the like.

In this embodiment of this application, an example in which the special effect is displayed is used as an example. However, in another embodiment, operation 804 does not need to be performed, and the special effect is no longer displayed.

In this embodiment of this application, the third scene location that the virtual object reaches after releasing the displacement skill is used as a skill landing point. The skill landing point is a location that the user expects the virtual object to reach. Therefore, regardless of whether the virtual object is currently in an idle state or is heading to a predicted scene location, when the third scene location is determined, the virtual object is immediately controlled to gradually move from a current display location to the third scene location, so that the virtual object moves to the third scene location, to ensure accuracy of skill release. In addition, this can avoid location teleport or jitter of the virtual object in a scene picture, and ensure that movement of the virtual object is displayed smoothly and continuously.

In the embodiment shown in FIG. 8, release of the displacement skill is used as an example for description. However, in another embodiment, the terminal calibrates a display location of the virtual object on the scene interface according to the embodiment shown in FIG. 8 in response to a release operation on another skill of the virtual object.

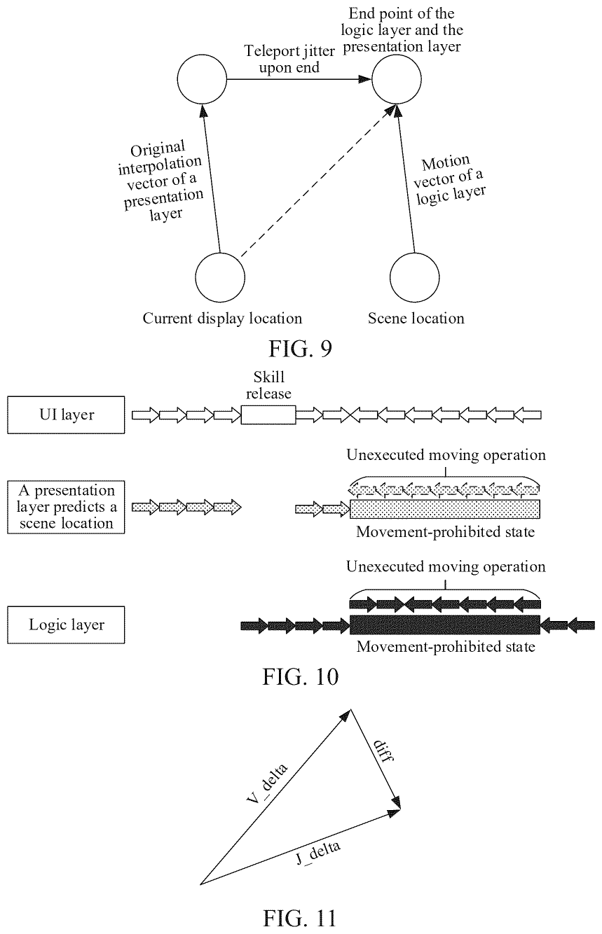

As shown in FIG. 9, if the terminal receives no skill release instruction returned by the server for the skill release request, the virtual object moves from the current display location on the scene interface based on an original interpolation vector of the presentation layer; or if the terminal receives the skill release instruction returned by the server for the skill release request and movement of the virtual object is not displayed according to the embodiment shown in FIG. 8, the terminal determines the third scene location through the logic layer based on a motion vector of the logic layer, and the virtual object moves from the current display location on the scene interface based on an original interpolation vector of the presentation layer, undergoes teleport jitter, and is then displayed at the third scene location. This causes teleport jitter of the virtual object on the scene interface. Therefore, according to the embodiment shown in FIG. 8, when the terminal receives the skill release instruction returned by the server for the skill release request, the terminal determines the third scene location, and displays the virtual object moving from the current display location to the third scene location, that is, moving along a dashed-line direction in FIG. 9.

In addition, when the user controls, on the scene interface displayed by the terminal, the virtual object to release a skill, the terminal displays an animation of the virtual object releasing the skill, to indicate that the virtual object is preparing to release the skill. In this case, if detecting a moving operation on the virtual object, the terminal controls the virtual object to move, which interrupts the skill release by the virtual object. Therefore, when detecting that the skill release by the virtual object is interrupted, the terminal displays movement of the virtual object on the scene interface.

In some embodiments, in response to a skill release operation on the virtual object, the terminal controls, through the logic layer, the virtual object to release a skill in the virtual scene; and in response to detecting, through the presentation layer, that the skill release by the virtual object is interrupted, displays movement of the virtual object on the scene interface.

In a game, a virtual object may be prohibited from moving when the virtual object is releasing a skill. Because no pre-presentation mechanism is applied to skill release by the virtual object but a pre-presentation mechanism is applied to a moving operation on the virtual object, in a process of displaying movement of the virtual object on the scene interface by using the pre-presentation mechanism, the terminal transmits a skill release request to the server in response to a skill release operation on the virtual object, and then the terminal displays skill release by the virtual object on the scene interface only when receiving a skill release instruction returned by the server for the skill release request. Therefore, a skill release process is performed only after time of a network delay elapses. Therefore, in a “movement-prohibited state” of a skill, a moving operation to which the presentation layer is prohibited from responding may be different from a moving operation to which the logic layer is prohibited from responding. In an entire movement and skill connection process, a moving operation performed in a pre-presentation manner is also different from a moving operation performed by the logic layer.

Based on the embodiments shown in FIG. 2 to FIG. 8, when the virtual object releases a skill in the virtual scene, the virtual object may be in a movement-prohibited state, to be specific, the virtual object may be unable to move in a process of releasing the skill in the virtual scene, and the skill may be a displacement skill or another skill. In addition, in this embodiment of this application, the pre-presentation mechanism is applied only to a moving operation on the virtual object, and no pre-presentation mechanism is applied to skill release by the virtual object. Therefore, the terminal displaying skill release by the virtual object on the scene interface may lag behind a skill release operation triggered by the user by using the terminal. To be specific, a skill release process is performed only after time of a network delay elapses. The user triggers a skill release operation on the virtual object on the scene interface displayed by the terminal, and the terminal transmits a skill release request to the server. If the terminal detects a moving operation on the virtual object when the terminal has not received a skill release instruction returned by the server, the terminal displays movement of the virtual object on the scene interface in the foregoing manner. When receiving a skill release instruction returned by the server for the skill release request, the terminal displays skill release by the virtual object on the scene interface. In this case, the virtual object is in a movement-prohibited state. When the virtual object is in the movement-prohibited state, the terminal may receive a moving instruction returned by the server for a target moving request. However, the terminal does not respond, through the logic layer, to the moving instruction corresponding to the target moving request. The target moving request is a moving request transmitted to the server before the skill release operation is triggered on the virtual object. However, the terminal has responded, through the presentation layer, to a moving operation corresponding to the target moving request. In addition, when the virtual object is in the movement-prohibited state, the terminal only transmits a moving request to the server in response to a moving operation on the virtual object on the scene interface, but does not display movement of the virtual object on the scene interface. When a status of the virtual object is updated to a movable state, the terminal transmits a moving request to the server in response to a moving operation on the virtual object on the scene interface, determines a predicted scene location based on the moving operation, and displays, on the scene interface, the virtual object moving toward the predicted scene location. Then, when receiving a moving instruction returned by the server for the moving request, the terminal determines whether to execute the moving instruction based on duration in which the virtual object is in the movement-prohibited state and operation duration of the moving operation corresponding to the moving request. The terminal does not execute a moving instruction received when the virtual object is in the movement-prohibited state. In addition, the terminal further calibrates a predicted scene location obtained when the movement-prohibited state of the virtual object ends, to eliminate impact caused by the terminal not executing a moving instruction received when the virtual object is in the movement-prohibited state. In this way, when the movement-prohibited state of the virtual object ends, the terminal can control movement of the virtual object based on a calibrated predicted scene location, so that a display location of the virtual object on the scene interface is consistent, as much as possible, with a scene location, recorded by the terminal, of the virtual object in the virtual scene.

In a possible implementation, a process of calibrating the predicted scene location obtained when the movement-prohibited state of the virtual object ends includes: When the virtual object is in the movement-prohibited state, the terminal determines, in response to a moving operation on the virtual object on the scene interface, a first displacement corresponding to the moving operation, determines a second displacement corresponding to an unexecuted moving instruction, determines a new predicted scene location based on a predicted scene location obtained when the virtual object starts to enter the movement-prohibited state, the first displacement, the second displacement, and a skill location. When the movement-prohibited state of the virtual object ends, the terminal displays, on the scene interface, the virtual object moving toward the new predicted scene location.

The unexecuted moving instruction is a moving instruction, among moving instructions that are received by the terminal and that are returned by the server for moving requests transmitted by the terminal, that corresponds to a moving time period falling within a time period in which the virtual object is in the movement-prohibited state. When receiving a skill release instruction returned by the server for a skill release request, the terminal determines a predicted scene location toward which the virtual object is to move on the scene interface. The predicted scene location is the predicted scene location obtained when the virtual object starts to enter the movement-prohibited state.

In some embodiments, determining the new predicted scene location based on the predicted scene location obtained when the virtual object starts to enter the movement-prohibited state, the first displacement, the second displacement, and the skill location meets the following relationships:

$$L\_end = R\_start + R\_forbid - L\_forbid + L\_skill$$

$$L\_end = L\_start + L\_skill + L\_undone$$

$$L\_start + L\_forbid + L\_undone = R\_start + R\_forbid$$

L_end is the new predicted scene location. To be specific, when the movement-prohibited state of the virtual object ends, the virtual object moving toward L_end is displayed on the scene interface, to calibrate a display location of the virtual object. R_start represents the predicted scene location obtained when the virtual object starts to enter the movement-prohibited state, to be specific, a predicted scene location obtained by the terminal through the presentation layer at a start moment of the “movement-prohibited state”. R_start is a known variable. R_forbid is the first displacement, to be specific, a displacement corresponding to a moving operation that has not been performed by the presentation layer because the virtual object is in the movement-prohibited state. L_forbid is the second displacement, to be specific, a displacement corresponding to a moving operation that has not been performed by the logic layer because the virtual object is in the movement-prohibited state. Both the first displacement and the second displacement can be calculated and updated based on respective moving directions when a logic frame and a presentation frame are updated. L_skill is a displacement caused by a released skill at the logic layer, to be specific, a displacement caused by a displacement skill when the skill is the displacement skill. L_skill is a known variable. L_start represents a scene location obtained by the terminal through the logic layer at the start moment of the “movement-prohibited state”. L_start is a known variable. L_undone represents a displacement corresponding to a moving instruction that has not been executed through the logic layer after the “movement-prohibited state” of skill ends.

As shown in FIG. 10, each arrow in FIG. 10 represents a moving operation, each arrow at a UI layer represents a moving operation triggered by a user, and a block at the UI layer represents a skill release operation. Each arrow at a presentation layer represents a response of the terminal to each moving operation through the presentation layer. To be specific, the terminal obtains a predicted scene location for each moving operation, and displays, on a scene interface, a virtual object moving toward the predicted scene location. Each arrow at a logic layer represents a response of the terminal to each moving operation through the logic layer. In a process in which the terminal responds to a moving operation at the UI layer through the presentation layer, when receiving a release instruction returned by the server for a skill release operation, the terminal determines that the virtual object is in a movement-prohibited state, and the terminal does not perform, through the presentation layer, moving operations represented by seven leftward moving operation arrows. In a process in which the terminal responds to a moving operation at the UI layer through the logic layer, when determining that the virtual object is in the movement-prohibited state, the terminal does not perform, through the logic layer, moving operations represented by two rightward moving operation arrows and five leftward moving operation arrows. However, when a status of the virtual object is updated to a movable state, in other words, when the movement-prohibited state of the virtual object ends, a new predicted scene location is determined in the foregoing manner, and the virtual object is controlled, through the presentation layer, to move toward the new predicted scene location.

Based on the embodiments shown in FIG. 2 to FIG. 10, the terminal can display the scene interface by using a frame synchronization technology. For example, a terminal divides a process of a game based on fixed time. At the beginning of each frame, a plurality of terminals participating in a same game have same game data. When receiving a moving instruction returned by the server, each terminal determines a next frame of game data based on the fixed time, and uses the next frame of game data as an initial state of a next frame. Advantages of this solution lie in high real-time performance and a small amount of data to be synchronized. This solution is suitable for network games that include frequent operations and require quick response, for example, MOBA games.

Based on the embodiments shown in FIG. 2 to FIG. 10, an embodiment of this application further provides an indicator based on movement and operation vectors as a criterion for quantizing movement manipulation hand feel. The criterion is applicable to various types of games, and the criterion can be used for detecting movement hand feel of a game. It is assumed that a moving direction unit vector is J_dir, a moving speed is v, and a time interval between presentation frame updates at the presentation layer is t, to be specific, interval duration between two adjacent presentation frames when the scene interface is displayed through the presentation layer is t. In this case, when the user triggers, by using the terminal, a moving operation to control the virtual object to move, an expected presentation layer displacement vector is as follows: J_delta=J_dir*v*t. After each update at the presentation layer, based on locations of the virtual object in two presentation frames before and after the update, a location displacement vector V_delta of the presentation layer is determined. Therefore, as shown in FIG. 11, a movement hand feel indicator is defined as follows: diff=|J_delta−V_delta|. diff represents modulus of a difference between an expected presentation layer displacement vector and an actual presentation layer displacement when the user triggers, by using the terminal, a moving operation to control the virtual object to move. A smaller value of diff indicates that movement at the presentation layer is closer to the moving operation triggered by the user by using the terminal, and indicates better hand feel. Calculation of the indicator is applicable to common games in which a joystick drives a character to move.

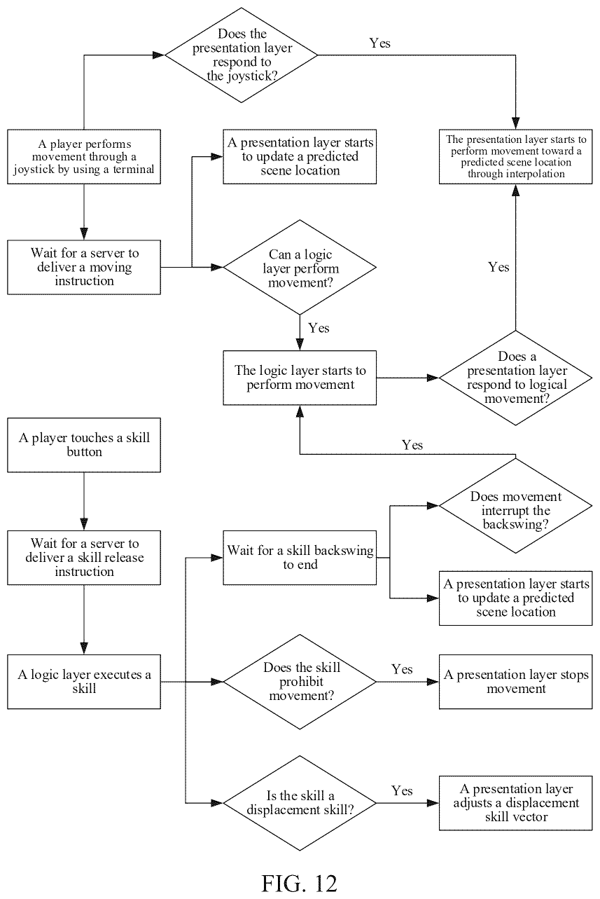

Based on the embodiments shown in FIG. 2 to FIG. 11, this application further provide a flowchart of another virtual object control method. As shown in FIG. 12, the method includes the following operations:

Operation 1: A player moves a virtual joystick by using a terminal. The terminal transmits a moving request to a server, to wait for the server to deliver a moving instruction, and when determining that a presentation layer needs to respond in a timely manner, predicts a scene location through the presentation layer, and displays, on a scene interface in an interpolation movement manner, a virtual object moving toward the predicted scene location.

Operation 2: When the terminal receives a moving instruction returned by the server for the moving request, the terminal determines a scene location when determining that a logic layer can perform movement, calibrates the predicted scene location through the presentation layer when the scene location is different from the predicted scene location, and displays the virtual object moving toward a calibrated predicted scene location.

Operation 3: The player triggers a skill button by using the terminal, and the terminal transmits a skill release request to the server, to wait for the server to deliver a skill release instruction.

Operation 4: The terminal receives the skill release instruction returned by the server, executes a skill through the logic layer, waits for a skill backswing to end, in other words, waits for skill release to end, displays skill release by the virtual object on the scene interface through the presentation layer, updates the predicted scene location, and displays the virtual object moving toward an updated predicted scene location.

Operation 5: The terminal determines whether to prohibit the virtual object from moving during execution of the skill, and if the virtual object is to be prohibited from moving during execution of the skill, displays, on the scene interface through the presentation layer, the virtual object being prohibited from moving; and determines whether the skill is a displacement skill, and if the skill is a displacement skill, determines a third scene location through the presentation layer according to the embodiment shown in FIG. 8, and displays the virtual object moving from a current display location to the third scene location.

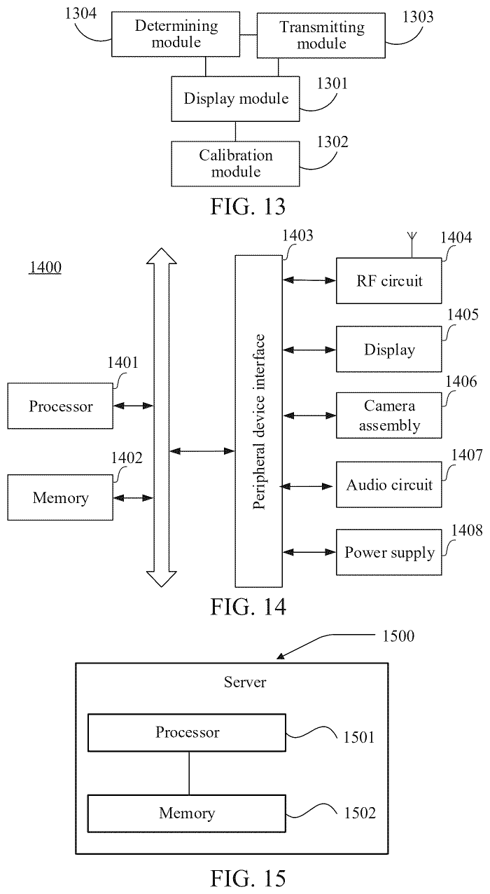

FIG. 13 is a schematic diagram of a structure of a virtual object control apparatus according to an embodiment of this application. As shown in FIG. 13, the apparatus includes:
a display module 1301, configured to display, on a scene interface in response to a first moving operation on a virtual object on the scene interface, the virtual object moving toward a first predicted scene location, the first predicted scene location being a location obtained by a local end through prediction based on the first moving operation; and
a calibration module 1302, configured to calibrate a display location of the virtual object on the scene interface based on a first scene location when the first scene location is different from the first predicted scene location, the first scene location being a location determined by the local end according to a moving instruction returned by a server for the first moving operation.

In a possible implementation, the apparatus further includes: a transmitting module 1303, configured to transmit a first moving request to the server in response to the first moving operation on the virtual object on the scene interface, the scene interface being an interface of a virtual scene, the first moving request carrying a first moving direction, and the first moving direction being a moving direction of the first moving operation;
a display module 1302, configured to obtain the first predicted scene location based on a current display location of the virtual object on the scene interface and the first moving direction, and display, on the scene interface, the virtual object moving toward the first predicted scene location; and
a determining module 1304, configured to determine the first scene location in response to the moving instruction returned by the server for the first moving request, the first scene location being a location that the virtual object is to reach in the virtual scene under the action of the first moving operation.

In another possible implementation, the display module 1301 is configured to determine a scene location corresponding to the display location in a virtual scene, the scene location being a current location of the virtual object in the virtual scene; and obtain the first predicted scene location based on the determined scene location, the first moving direction, a moving speed of the virtual object, and operation duration of the first moving operation.

In another possible implementation, the calibration module 1302 is configured to display, on the scene interface, the virtual object moving toward the first scene location when the virtual object moves toward the first predicted scene location and the first scene location is different from the first predicted scene location.

In another possible implementation, the calibration module 1302 is configured to display, on the scene interface, the virtual object moving toward the first scene location when the virtual object has moved to the first predicted scene location and is in an idle state and the first scene location is different from the first predicted scene location.

In another possible implementation, the display module 1301 is configured to display, on the scene interface in response to a second moving operation on the virtual object, the virtual object moving toward a second predicted scene location, the second predicted scene location being a location predicted by the local end based on the second moving operation.

In another possible implementation, the transmitting module 1303 is further configured to transmit a second moving request to the server in response to the second moving operation on the virtual object, the second moving request carrying a second moving direction, and the second moving direction being a moving direction of the second moving operation; and
the display module 1301 is further configured to obtain a second predicted scene location based on a current display location of the virtual object on the scene interface and the second moving direction, and display, on the scene interface, the virtual object moving toward the second predicted scene location, the second predicted scene location being a predicted location that the virtual object is to reach in the virtual scene under the action of the second moving operation.

In another possible implementation, the calibration module 1302 is configured to calibrate the second predicted scene location based on a difference between the first scene location and the first predicted scene location when the virtual object moves toward the second predicted scene location and the first scene location is different from the first predicted scene location, and display, on the scene interface, the virtual object moving toward a calibrated second predicted scene location.

In another possible implementation, the display module 1301 is further configured to display, on the scene interface in response to a third moving operation on the virtual object, the virtual object moving toward a third predicted scene location, the third predicted scene location being a location predicted by the local end based on the third moving operation; and
the calibration module 1302 is configured to calibrate the second predicted scene location and the third predicted scene location based on a difference between the first scene location and the first predicted scene location when the virtual object moves toward the second predicted scene location and the first scene location is different from the first predicted scene location, and display, on the scene interface, the virtual object moving toward a calibrated second predicted scene location.

In another possible implementation, the transmitting module 1303 is further configured to transmit a third moving request to the server in response to the third moving operation on the virtual object, the third moving request carrying a third moving direction, and the third moving direction being a moving direction of the third moving operation; and
the display module 1301 is further configured to obtain the third predicted scene location based on a current display location of the virtual object on the scene interface and the third moving direction, and display, on the scene interface, the virtual object moving toward the third predicted scene location.

In another possible implementation, the calibration module 1302 is further configured to re-calibrate the calibrated second predicted scene location based on a difference between a second scene location and a calibrated third predicted scene location when the virtual object moves toward the calibrated second predicted scene location and the second scene location is different from the calibrated third predicted scene location, and display, on the scene interface, the virtual object moving toward a re-calibrated second predicted scene location, the first scene location being a location determined by the local end according to a moving instruction returned by the server for the third moving operation.

In another possible implementation, the display module 1301 is configured to perform collision detection on the current display location of the virtual object on the scene interface, the first moving direction, and an environmental parameter of the virtual scene to obtain a collision result, the environmental parameter indicating an obstacle in the virtual scene, and the collision result indicating a collision status when the virtual object moves toward the first moving direction in the virtual scene; and obtain the first predicted scene location based on the collision result, the current display location of the virtual object on the scene interface, and the first moving direction.

In another possible implementation, the transmitting module 1303 is further configured to transmit a skill release request to the server in response to a release operation on a displacement skill of the virtual object, the skill release request carrying the displacement skill and a displacement direction of the displacement skill;
the determining module 1304 is further configured to determine, in response to a skill release instruction returned by the server for the skill release request, a third scene location based on a scene location of the virtual object at which the displacement skill is released and the displacement skill and the displacement direction that are in the skill release instruction, the third scene location being a location reached by the virtual object after the virtual object releases the displacement skill in the virtual scene; and
the display module 1301 is further configured to display, on the scene interface, the virtual object moving from the current display location toward the third scene location.

In another possible implementation, the display module 1301 is further configured to display, in a process in which the virtual object moves toward the third scene location, a special effect of the virtual object releasing the displacement skill.

In another possible implementation, the display module 1301 is configured to obtain an i^{th} first predicted scene location based on a scene location corresponding to the display location in the virtual scene, the first moving direction, and a time step; display, on the scene interface, the virtual object moving toward the i^{th} first predicted scene location, i being an integer greater than 0; obtain an (i+1)^{th} first predicted scene location based on the i^{th} first predicted scene location, the first moving direction, and the time step; and when the virtual object has moved to the i^{th} first predicted scene location, display, on the scene interface, the virtual object moving toward the (i+1)^{th} first predicted scene location.

The virtual object control apparatus provided in the foregoing embodiments is described by using division of the foregoing functional modules as an example. During actual application, the foregoing functions can be allocated to and completed by different functional modules as needed. To be specific, an internal structure of a computer device is divided into different functional modules to implement all or some of the functions described above. In addition, the virtual object control apparatus provided in the foregoing embodiments and the virtual object control method embodiments belong to a same concept. For details about a specific implementation process of the virtual object control apparatus, refer to the method embodiments. Details are not described herein again.

The embodiments of this application further provide a computer device. The computer device includes a processor and a memory. The memory has at least one computer program stored therein. The at least one computer program is loaded and executed by the processor to implement the operations performed in the virtual object control method in the foregoing embodiments.

In some embodiments, the computer device is provided as a terminal. FIG. 14 is a block diagram of a structure of a terminal 1400 according to an exemplary embodiment of this application. The terminal 1400 may be a smartphone, a tablet computer, a notebook computer, a desktop computer, a smart speaker, a smartwatch, a smart voice interaction device, a smart home appliance, an in-vehicle terminal, or the like. The terminal 1400 may also be referred to as another name such as user equipment, a portable terminal, a laptop terminal, or a desktop terminal.

The terminal 1400 includes a processor 1401 and a memory 1402.

The processor 1401 may include one or more processing cores, for example, a 4-core processor or an 8-core processor. The processor 1401 may be implemented in at least one hardware form of a digital signal processor (DSP), a field programmable gate array (FPGA), or a programmable logic array (PLA). The processor 1401 may alternatively include a main processor and a coprocessor. The main processor is a processor configured to process data in an awake state, and is also referred to as a central processing unit (CPU). The coprocessor is a low-power processor configured to process data in a standby state. In some embodiments, the processor 1401 may be integrated with a graphics processing unit (GPU). The GPU is configured to render and draw content that needs to be displayed on a display. In some embodiments, the processor 1401 may further include an AI processor. The AI processor is configured to process computing operations related to machine learning.

The memory 1402 may include one or more computer-readable storage media. The computer-readable storage medium may be non-transient. The memory 1402 may further include a high-speed random access memory and a nonvolatile memory, for example, one or more disk storage devices or flash storage devices. In some embodiments, the non-transient computer-readable storage medium in the memory 1402 is configured to store at least one computer program. The at least one computer program is configured for being executed by the processor 1401 to implement the virtual object control method provided in the method embodiments of this application.

In some embodiments, the terminal 1400 further includes a peripheral device interface 1403 and at least one peripheral device. The processor 1401, the memory 1402, and the peripheral device interface 1403 may be connected through a bus or a signal cable. Each peripheral device may be connected to the peripheral device interface 1403 through a bus, a signal cable, or a circuit board. Specifically, the peripheral device includes at least one of a radio frequency (RF) circuit 1404, a display 1405, a camera assembly 1406, an audio circuit 1407, and a power supply 1408.

The peripheral device interface 1403 may be configured to connect the at least one peripheral related to input/output (I/O) to the processor 1401 and the memory 1402. In some embodiments, the processor 1401, the memory 1402, and the peripheral device interface 1403 are integrated on a same chip or circuit board. In some other embodiments, any one or two of the processor 1401, the memory 1402, and the peripheral device interface 1403 may be implemented on a separate chip or circuit board. This is not limited in this embodiment.

The RF circuit 1404 is configured to receive and transmit an RF signal, also referred to as an electromagnetic signal. The RF circuit 1404 communicates with a communication network and other communication devices through the electromagnetic signal. The RF circuit 1404 converts an electrical signal into an electromagnetic signal for transmission, or converts a received electromagnetic signal into an electrical signal. In some embodiments, the RF circuit 1404 includes an antenna system, an RF transceiver, one or more amplifiers, a tuner, an oscillator, a DSP, a codec chipset, a subscriber identity module card, and the like. The RF circuit 1404 may communicate with another terminal through at least one wireless communication protocol. The wireless communication protocol includes but is not limited to the World Wide Web, a metropolitan area network, an intranet, various generations of mobile communication networks (2G, 3G, 4G, and 5G), a wireless local area network, and/or a wireless fidelity (Wi-Fi) network. In some embodiments, the RF circuit 1404 may further include a circuit related to near field communication (NFC). This is not limited in this application.

The display 1405 is configured to display a user interface (UI). The UI may include a graph, text, an icon, a video, and any combination thereof. When the display 1405 is a touch display, the display 1405 is further capable of capturing a touch signal on or above a surface of the display 1405. The touch signal may be inputted to the processor 1401 as a control signal for processing. In this case, the display 1405 may be further configured to provide a virtual button and/or a virtual keyboard, which are/is also referred to as a soft button and/or a soft keyboard. In some embodiments, there may be one display 1405, which is arranged on a front panel of the terminal 1400. In some other embodiments, there may be at least two displays 1405, which are respectively arranged on different surfaces of the terminal 1400 or designed in a folded form. In some other embodiments, the display 1405 may be a flexible display disposed on a curved surface or a folded surface of the terminal 1400. Alternatively, the display 1405 may be even arranged in a non-rectangular irregular pattern, namely, a special-shaped screen. The display 1405 may be made of a liquid crystal display (LCD), an organic light-emitting diode (OLED), or other materials.

The camera assembly 1406 is configured to capture images or videos. In some embodiments, the camera assembly 1406 includes a front-facing camera and a rear-facing camera. The front-facing camera is arranged on the front panel of the terminal, and the rear-facing camera is arranged on a rear side of the terminal. In some embodiments, there are at least two rear-facing cameras, each of which is any one of a main camera, a depth-of-field camera, a wide-angle camera, and a telephoto camera, to implement a background blur function through fusion of the main camera and the depth-of-field camera, and implement a panoramic photographing function and a VR photographing function or other fusion photographing functions through fusion of the main camera and the wide-angle camera. In some embodiments, the camera assembly 1406 may further include a flash. The flash may be a mono color temperature flash or a double color temperature flash. The double color temperature flash is a combination of a warm light flash and a cold light flash, and may be used for light compensation under different color temperatures.

The audio circuit 1407 may include a microphone and a speaker. The microphone is configured to capture sound waves of a user and an environment, and convert the sound waves into an electrical signal to input to the processor 1401 for processing, or input to the RF circuit 1404 for implementing voice communication. To capture stereo or reduce noise, there may be a plurality of microphones, which are respectively disposed at different portions of the terminal 1400. The microphone may alternatively be an array microphone or an omni-directional capture microphone. The speaker is configured to convert an electrical signal from the processor 1401 or the RF circuit 1404 into a sound wave. The speaker may be a conventional film speaker or a piezoelectric ceramic speaker. When the speaker is a piezoelectric ceramic speaker, the speaker not only can convert an electrical signal into a sound wave audible to a human being, but also can convert an electrical signal into a sound wave inaudible to a human being, for ranging and other purposes. In some embodiments, the audio circuit 1407 may further include a headset jack.

The power supply 1408 is configured to supply power to components in the terminal 1400. The power supply 1408 may be an alternating current power supply, a direct current power supply, a disposable battery, or a rechargeable battery. When the power supply 1408 includes a rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

A person skilled in the art may understand that the structure shown in FIG. 14 constitutes no limitation on the terminal 1400, and the terminal may include more or fewer components than those shown in the figure, or some components may be combined, or different component layouts may be used.

In some embodiments, the computer device is provided as a server. FIG. 15 is a schematic diagram of a structure of a server according to an embodiment of this application. The server 1500 may vary greatly due to different configurations or performance, and may include one or more CPUs 1501 and one or more memories 1502. The memory 1502 has at least one computer program stored therein. The at least one computer program is loaded and executed by the processor 1501 to implement the methods provided in the foregoing method embodiments. Certainly, the server may further include components such as a wired or wireless network interface, a keyboard, and an I/O interface for input and output. The server may further include another component for implementing a device function. Details are not described herein.

The embodiments of this application further provide a non-transitory computer-readable storage medium. The computer-readable storage medium has at least one computer program stored therein. The at least one computer program is loaded and executed by a processor to implement the operations performed in the virtual object control method in the foregoing embodiments.

The embodiments of this application further provide a computer program product, including a computer program. When the computer program is executed by a processor, the operations performed in the virtual object control method in the foregoing embodiments are implemented.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. The foregoing descriptions are merely exemplary embodiments of the embodiments of this application, but are not intended to limit the embodiments of this application. Any modification, equivalent replacement, or improvement made within the spirit and principle of the embodiments of this application shall fall within the protection scope of this application.

What is claimed is:

1. A virtual object control method performed by a computer device, the method comprising:
in response to a first moving operation on a virtual object on a scene interface, predicting a first scene location based on the first moving operation and moving the virtual object toward the first predicted scene location;
determining a first scene location according to a moving instruction returned by a server for the first moving operation; and
calibrating a display location of the virtual object on the scene interface based on the first scene location when the first scene location is different from the first predicted scene location.

2. The method according to claim 1, wherein the predicting a first predicted scene location based on the first moving operation and moving the virtual object toward the first predicted scene location comprises:
transmitting a first moving request to the server in response to the first moving operation, the first moving request carrying a first moving direction of the first moving operation;
obtaining the first predicted scene location based on a current display location of the virtual object on the scene interface and the first moving direction; and
moving, on the scene interface, the virtual object toward the first predicted scene location.

3. The method according to claim 2, wherein the obtaining the first predicted scene location based on a current display location of the virtual object on the scene interface and the first moving direction comprises:
determining a current location of the virtual object in a virtual scene; and
obtaining the first predicted scene location based on the current location, the first moving direction, a moving speed of the virtual object, and an operation duration of the first moving operation.

4. The method according to claim 1, wherein the calibrating the display location of the virtual object on the scene interface based on the first scene location when the first scene location is different from the first predicted scene location comprises:
moving, on the scene interface, the virtual object toward the first scene location when the virtual object moves toward the first predicted scene location and the first scene location is different from the first predicted scene location.

5. The method according to claim 1, wherein the calibrating the display location of the virtual object on the scene interface based on the first scene location when the first scene location is different from the first predicted scene location comprises:
moving, on the scene interface, the virtual object toward the first scene location when the virtual object has moved to the first predicted scene location and is in an idle state and the first scene location is different from the first predicted scene location.

6. The method according to claim 1, wherein before the calibrating the display location of the virtual object on the scene interface based on the first scene location when the first scene location is different from the first predicted scene location, the method further comprises:
in response to a second moving operation on the virtual object, predicting a second scene location based on the second moving operation and moving the virtual object toward the second predicted scene location.

7. The method according to claim 2, wherein the obtaining the first predicted scene location based on the current display location of the virtual object on the scene interface and the first moving direction comprises:
performing collision detection on the current display location of the virtual object on the scene interface, the first moving direction, and an environmental parameter of the virtual scene to obtain a collision result, the environmental parameter indicating an obstacle in the virtual scene, and the collision result indicating a collision status when the virtual object moves toward the first moving direction in the virtual scene; and
obtaining the first predicted scene location based on the collision result, the current display location of the virtual object on the scene interface, and the first moving direction.

8. The method according to claim 1, wherein the method further comprises:
transmitting a skill release request to the server in response to a release operation on a displacement skill of the virtual object, the skill release request carrying the displacement skill and a displacement direction of the displacement skill;
in response to a skill release instruction returned by the server for the skill release request, determining a third scene location based on a scene location of the virtual object at which the displacement skill is released and the displacement skill and the displacement direction that are in the skill release instruction, the third scene location being a location reached by the virtual object after the virtual object releases the displacement skill in the virtual scene; and
moving, on the scene interface, the virtual object from the current display location toward the third scene location.

9. The method according to claim 8, wherein the method further comprises:
displaying, in a process in which the virtual object moves toward the third scene location, a special effect of the virtual object releasing the displacement skill.

10. A computer device comprising a processor and a memory, the memory having at least one computer program stored therein, and the at least one computer program, when executed by the processor, causing the computer device to implement a virtual object control method including:
in response to a first moving operation on a virtual object on a scene interface, predicting a first scene location based on the first moving operation and moving the virtual object toward the first predicted scene location;
determining a first scene location according to a moving instruction returned by a server for the first moving operation; and
calibrating a display location of the virtual object on the scene interface based on the first scene location when the first scene location is different from the first predicted scene location.

11. The computer device according to claim 10, wherein the predicting a first predicted scene location based on the first moving operation and moving the virtual object toward the first predicted scene location comprises:
transmitting a first moving request to the server in response to the first moving operation, the first moving request carrying a first moving direction of the first moving operation;
obtaining the first predicted scene location based on a current display location of the virtual object on the scene interface and the first moving direction; and
moving, on the scene interface, the virtual object toward the first predicted scene location.

12. The computer device according to claim 11, wherein the obtaining the first predicted scene location based on a current display location of the virtual object on the scene interface and the first moving direction comprises:
determining a current location of the virtual object in a virtual scene; and
obtaining the first predicted scene location based on the current location, the first moving direction, a moving speed of the virtual object, and an operation duration of the first moving operation.

13. The computer device according to claim 10, wherein the calibrating the display location of the virtual object on the scene interface based on the first scene location when the first scene location is different from the first predicted scene location comprises:
moving, on the scene interface, the virtual object toward the first scene location when the virtual object moves toward the first predicted scene location and the first scene location is different from the first predicted scene location.

14. The computer device according to claim 10, wherein the calibrating the display location of the virtual object on the scene interface based on the first scene location when the first scene location is different from the first predicted scene location comprises:
moving, on the scene interface, the virtual object toward the first scene location when the virtual object has moved to the first predicted scene location and is in an idle state and the first scene location is different from the first predicted scene location.

15. The computer device according to claim 10, wherein before the calibrating the display location of the virtual object on the scene interface based on the first scene location when the first scene location is different from the first predicted scene location, the method further comprises:
in response to a second moving operation on the virtual object, predicting a second scene location based on the second moving operation and moving the virtual object toward the second predicted scene location.

16. The computer device according to claim 11, wherein the obtaining the first predicted scene location based on the current display location of the virtual object on the scene interface and the first moving direction comprises:
performing collision detection on the current display location of the virtual object on the scene interface, the first moving direction, and an environmental parameter of the virtual scene to obtain a collision result, the environmental parameter indicating an obstacle in the virtual scene, and the collision result indicating a collision status when the virtual object moves toward the first moving direction in the virtual scene; and
obtaining the first predicted scene location based on the collision result, the current display location of the virtual object on the scene interface, and the first moving direction.

17. The computer device according to claim 10, wherein the method further comprises:
transmitting a skill release request to the server in response to a release operation on a displacement skill of the virtual object, the skill release request carrying the displacement skill and a displacement direction of the displacement skill;
in response to a skill release instruction returned by the server for the skill release request, determining a third scene location based on a scene location of the virtual object at which the displacement skill is released and the displacement skill and the displacement direction that are in the skill release instruction, the third scene location being a location reached by the virtual object after the virtual object releases the displacement skill in the virtual scene; and
moving, on the scene interface, the virtual object from the current display location toward the third scene location.

18. The computer device according to claim 17, wherein the method further comprises:
displaying, in a process in which the virtual object moves toward the third scene location, a special effect of the virtual object releasing the displacement skill.

19. A non-transitory computer-readable storage medium having at least one computer program stored therein, and the at least one computer program, when executed by a processor of a computer device, causing the computer device to implement a virtual object control method including:
in response to a first moving operation on a virtual object on a scene interface, predicting a first scene location based on the first moving operation and moving the virtual object toward the first predicted scene location;
determining a first scene location according to a moving instruction returned by a server for the first moving operation; and
calibrating a display location of the virtual object on the scene interface based on the first scene location when the first scene location is different from the first predicted scene location.

20. The non-transitory computer-readable storage medium according to claim 19, wherein the predicting a first predicted scene location based on the first moving operation and moving the virtual object toward the first predicted scene location comprises:
transmitting a first moving request to the server in response to the first moving operation, the first moving request carrying a first moving direction of the first moving operation;
obtaining the first predicted scene location based on a current display location of the virtual object on the scene interface and the first moving direction; and
moving, on the scene interface, the virtual object toward the first predicted scene location.
